(19) United States
(12) Patent Application Publication
(10) Pub. No.: US 2026/0145989 A1
(43) Pub. Date: May 28, 2026

(54) ION EXCHANGEABLE GLASS ARTICLES HAVING IMPROVED MECHANICAL DURABILITY

(71) Applicant: CORNING INCORPORATED, CORNING, NY (US)

(72) Inventors: Timothy James Kiczenski, Corning, NY (US); Peter Joseph Lezzi, Corning, NY (US); Jonathan David Pesansky, Corning, NY (US)

(21) Appl. No.: 19/178,019

(22) Filed: Apr. 14, 2025

Related U.S. Application Data
(60) Provisional application No. 63/636,230, filed on Apr. 19, 2024.

(51) Int. Cl. C03C 3/085; C03C 21/00

(52) U.S. Cl. CPC C03C 3/085; C03C 21/005; C03C 2201/10; C03C 2201/28; C03C 2201/32; C03C 2201/50

(57) ABSTRACT

A glass article includes SiO₂, Al₂O₃, and Na₂O. B₂O₃+P₂O₅ may be greater than 0 mol % to 10 mol %. R₂O may be from 10 mol % to 20 mol %. R₂O—Al₂O₃ may be from 0 mol % to 10 mol %. RO may be from 0 mol % to 10 mol %. (R₂O+RO)—(Al₂O₃+B₂O₃) from −5 mol % to 10 mol %. The glass article may include a ratio of peak compressive stress to Young's modulus greater than or equal to 13, after the glass article is ion exchanged in a 100% KNO₃ salt bath at 410° C. for 30 minutes; a Knoop scratch threshold greater than 5 N; a difference between a zirconium breakdown temperature and a liquidus temperature at a 35 kP temperature greater than or equal to −35° C.; and a 200 P temperature less than or equal to 1720° C.

### CROSS-REFERENCE TO RELATED APPLICATIONS

This application claims the benefit of priority of U.S. Provisional Application Ser. No. 63/636,230, filed on Apr. 19, 2024, the content of which is relied upon and incorporated herein by reference in its entirety.

### FIELD

The present specification generally relates to ion exchangeable glass articles and, in particular, to ion exchangeable glass articles having bendability, scratch resistance and manufacturability for cover glass applications, for example, a cover glass for a flexible display.

### TECHNICAL BACKGROUND

Many consumer products, for example smart phones, tablets, portable media players, personal computers, and cameras, incorporate cover glasses that may function as display covers, and may incorporate touch functionality. Frequently, these devices are dropped by users onto hard surfaces, which can cause damage to the cover glasses, and may negatively impact the use of the devices, for example, the touch functionality may be compromised.

Foldable or flexible displays for consumer electronics applications may benefit from thin, flexible ion exchanged glass articles. Glass articles may be made more resistant to flexure failure through ion exchange processes, which involve inducing compressive stresses on the glass surfaces. The compressive stress introduced using an ion exchange process serves to, among other things, arrest flaws that can cause failure of the glass article.

Therefore, a continuing need exists for ion exchangeable glass articles having desirable mechanical properties for use in a variety of applications, including cover glass applications.

### SUMMARY

According to a first aspect A1, a glass article comprises: greater than or equal to 58 mol % and less than or equal to 75 mol % SiO₂; greater than or equal to 10 mol % and less than or equal to 20 mol % Al₂O₃; greater than or equal to 0 mol % and less than or equal to 8 mol % B₂O₃; greater than or equal to 0 mol % and less than or equal to 6 mol % P₂O₅; and greater than or equal to 10 mol % and less than or equal to 20 mol % Na₂O, wherein B₂O₃+P₂O₅ is greater than 0 mol % and less than or equal to 10 mol %; R₂O is greater than or equal to 10 mol % and less than or equal to 20 mol %, wherein R₂O is the sum of Na₂O, Li₂O, and K₂O; R₂O—Al₂O₃ is greater than or equal to 0 mol % and less than or equal to 10 mol %; RO is greater than or equal to 0 mol % and less than or equal to 10 mol %, wherein RO is the sum of MgO, CaO, SrO, and ZnO; (R₂O+RO)—(Al₂O₃+B₂O₃) is greater than or equal to −5 mol % and less than or equal to 10 mol %; and the glass article comprises: a peak compressive stress (CS) and a Young's modulus (E), a ratio of the CS to the E being greater than or equal to 13, after the glass article is ion exchanged in a 100% KNO₃ salt bath at 410° C. for 30 minutes; a Knoop scratch threshold greater than 5 N; a zirconium breakdown temperature (T_{Zr}) and a 35 kP temperature (T₃₅ₖ), wherein a difference between the T_{Zr} and the T₃₅ₖ being greater than or equal to −35° C.; and 200 P temperature (T₂₀₀) less than or equal to 1720° C.

A second aspect A2 includes the glass article of the first aspect A1, wherein the glass article comprises a liquidus viscosity greater than or equal to 100 kP.

A third aspect A3 includes the glass article of the second aspect A2, wherein the liquidus viscosity is greater than or equal to 500 kP.

A fourth aspect A4 includes the glass article of any one of the first through third aspects A1-A3, wherein the ratio of the CS to the E is greater than or equal to 14.

A fifth aspect A5 includes the glass article of any one of the first through fourth aspects A1-A4, wherein the Knoop scratch threshold is greater than or equal to 6 N.

A sixth aspect A6 includes the glass article of any one of the first through fifth aspects A1-A5, wherein the difference between the T_{Zr} and the T₃₅ₖ is greater than or equal to −30° C.

A seventh aspect A7 includes the glass article of any one of the first through sixth aspects A1-A6, wherein the T₂₀₀ is less than or equal to 1700° C.

An eighth aspect A8 includes the glass article of any one of the first through seventh aspects A1-A7, wherein T₃₅ₖ is greater than or equal to 1050° C. and less than or equal to 1350° C.

A ninth aspect A9 includes the glass article of any one of the first through eighth aspects A1-A8, wherein the glass article comprises a thickness greater than or equal to 30 μm and less than or equal to 5000 μm.

A tenth aspect A10 includes the glass article of any one of the first through ninth aspects A1-A9, the CS is greater than or equal to 750 MPa and less than or equal to 1200 MPa, after the glass article is ion exchanged in a 100% KNO₃ salt bath at 410° C. for 30 minutes; the E is greater than or equal to 50 GPa and less than or equal to 100 GPa; and the T_{Zr} is greater than or equal to 950° C. and less than or equal to 1450° C.

An eleventh aspect A11 includes the glass article of any one of the first through tenth aspects A1-A10, wherein the glass comprises greater than or equal to 11 mol % and less than or equal to 18 mol % Al₂O₃.

A twelfth aspect A12 includes the glass article of any one of the first through eleventh aspects A1-A11, wherein B₂O₃+P₂O₅ is greater than or equal to 0.5 mol % and less than or equal to 8 mol %.

A thirteenth aspect A13 includes the glass article of any one of the first through twelfth aspects A1-A12, wherein the glass comprises greater than or equal to 0.5 mol % and less than or equal to 7 mol % B₂O₃.

A fourteenth aspect A14 includes the glass article of any one of the first through thirteenth aspects A1-A13, wherein the glass article comprises greater than or equal to 0.5 mol % and less than or equal to 5 mol % P₂O₅.

A fifteenth aspect A15 includes the glass article of any one of the first through fourteenth aspects A1-A14, wherein the glass article comprises greater than or equal to 12 mol % and less than or equal to 18 mol % Na₂O.

A sixteenth aspect A16 includes the glass article of any one of the first through fifteenth aspects A1-A15, wherein R₂O is greater than or equal to 12 mol % and less than or equal to 18 mol %.

A seventeenth aspect A17 includes the glass article of any one of the first through sixteenth aspects A1-A16, wherein R₂O—Al₂O₃ is greater than or equal to 0.5 mol % and less than or equal to 6 mol %.

An eighteenth aspect A18 includes the glass article of any one of the first through seventeenth aspects A1-A17, wherein RO is greater than or equal to 1 mol % and less than or equal to 6 mol %.

A nineteenth aspect A19 includes the glass article of any one of the first through eighteenth aspects A1-A18, wherein (R₂O+RO)—(Al₂O₃+B₂O₃) is greater than or equal to −3 mol % and less than or equal to 9 mol %.

A twentieth aspect A20 includes the glass article of any one of the first through nineteenth aspects A1-A19, wherein the glass article comprises greater than 0 mol % and less than or equal to 7 mol % MgO.

A twenty-first aspect A21 includes the glass article of any one of the first through twentieth aspects A1-A20, wherein the glass article comprises greater than 0 mol % and less than or equal to 5 mol % CaO.

A twenty-second aspect A22 includes the glass article of any one of the first through twenty-first aspects A1-A21, wherein the glass article comprises greater than 0 mol % and less than or equal to 5 mol % SrO.

A twenty-third aspect A23 includes the glass article of any one of the first through twenty-second aspects A1-A22, wherein the glass article comprises greater than 0 mol % and less than or equal to 5 mol % ZnO.

A twenty-fourth aspect A24 includes the glass article of any one of the first through twenty-third aspects A1-A23, wherein the glass article comprises greater than 0 mol % and less than or equal to 5 mol % Li₂O.

A twenty-fifth aspect A25 includes the glass article of any one of the first through twenty-fourth aspects A1-A24, wherein the glass article comprises greater than 0 mol % and less than or equal to 5 mol % K₂O.

According to a twenty-sixth aspect A26, a consumer electronic device comprises: a housing having a front surface, a back surface, and side surfaces; electrical components provided at least partially within the housing, the electrical components including at least a controller, a memory, and a display, the display being provided at or adjacent the front surface of the housing; and the glass article of any one of any one of the first through twenty-fifth aspects A1-A25 disposed over the display.

According to a twenty-seventh aspect A27, a glass article comprises: greater than or equal to 58 mol % and less than or equal to 68 mol % SiO₂; greater than or equal to 11 mol % and less than or equal to 16 mol % Al₂O₃; greater than or equal to 0 mol % and less than or equal to 7 mol % B₂O₃; greater than or equal to 0 mol % and less than or equal to 5 mol % P₂O₅; and greater than or equal to 13 mol % and less than or equal to 17 mol % Na₂O, wherein B₂O₃+P₂O₅ is greater than 1 mol % and less than or equal to 7 mol %; R₂O is greater than or equal to 13 mol % and less than or equal to 17 mol %, wherein R₂O is the sum of Na₂O, Li₂O, and K₂O; R₂O—Al₂O₃ is greater than or equal to 0 mol % and less than or equal to 4 mol %; RO is greater than or equal to 2 mol % and less than or equal to 5 mol %, wherein RO is the sum of MgO, CaO, SrO, and ZnO; (R₂O+RO)—(Al₂O₃+B₂O₃) is greater than or equal to −3 mol % and less than or equal to 7 mol %; and the glass article comprises: a peak compressive stress (CS) and a Young's modulus (E), a ratio of the CS to the E being greater than or equal to 13, after the glass article is ion exchanged in a 100% KNO₃ salt bath at 410° C. for 30 minutes; a Knoop scratch threshold greater than 5 N; a zirconium breakdown temperature (T_{Zr}) and a 35 kP temperature (T₃₅ₖ), wherein a difference between the T_{Zr} and the T₃₅ₖ being greater than or equal to −35° C.; and a 200 P temperature (T₂₀₀) less than or equal to 1720° C.

A twenty-eighth aspect A28 includes the glass article of the twenty-seventh aspect A27, wherein the glass article comprises a liquidus viscosity greater than or equal to 200 kP.

A twenty-ninth aspect A29 includes the glass article of the twenty-seventh aspect A27 or the twenty-eighth aspect A28, wherein the ratio of the CS to the E is greater than or equal to 14.

A thirtieth aspect A30 includes the glass article of any one of the twenty-seventh through twenty-ninth aspects A27-A29, wherein the Knoop scratch threshold is greater than or equal to 6 N.

A thirty-first aspect A31 includes the glass article of any one of the twenty-seventh through thirtieth aspects A27-A30, wherein the difference between the T_{Zr} and the T₃₅ₖ is greater than or equal to −30° C.

A thirty-second aspect A32 includes the glass article of any one of the twenty-seventh through thirty-first aspects A27-A31, wherein the T₂₀₀ is less than or equal to 1700° C.

A thirty-third aspect A33 includes the glass article of any one of the twenty-seventh through thirty-second aspects A27-A32, wherein the T₃₅ₖ is greater than or equal to 1100° C. and less than or equal to 1300° C.

A thirty-fourth aspect A34 includes the glass article of any one of the twenty-seventh through thirty-third aspects A27-A33, wherein the glass article comprises a thickness greater than or equal to 30 μm and less than or equal to 5000 μm.

A thirty-fifth aspect A35 includes the glass article of any one of the twenty-seventh through thirty-fourth aspects A27-A34, wherein: the CS is greater than or equal to 850 MPa and less than or equal to 1100 MPa, after the glass article is ion exchanged in a 100% KNO₃ salt bath at 410° C. for 30 minutes; the E is greater than or equal to 60 GPa and less than or equal to 75 GPa; and the T_{Zr} is greater than or equal to 1100° C. and less than or equal to 1300° C.

A thirty-sixth aspect A36 includes the glass article of any one of the twenty-seventh through thirty-fifth aspects A27-A35, wherein the glass article comprises greater than or equal to 1 mol % and less than or equal to 5 mol % MgO.

A thirty-seventh aspect A37 includes the glass article of any one of the twenty-seventh through thirty-sixth aspects A27-A36, wherein the glass article comprises greater than 0 mol % and less than or equal to 1 mol % CaO.

A thirty-eighth aspect A38 includes the glass article of any one of the twenty-seventh through thirty-seventh aspects A27-A37, wherein the glass article comprises greater than 0 mol % and less than or equal to 1 mol % SrO.

A thirty-ninth aspect A39 includes the glass article of any one of the twenty-seventh through thirty-eighth aspects A27-A38, wherein the glass article comprises greater than 0 mol % and less than or equal to 2 mol % ZnO.

A fortieth aspect A40 includes the glass article of any one of the twenty-seventh through thirty-ninth aspects A27-A39, wherein the glass article comprises greater than 0 mol % and less than or equal to 3 mol % Li₂O.

A forty-first aspect A41 includes the glass article of any one of the twenty-seventh through fortieth aspects A27-A40, wherein the glass article comprises greater than 0 mol % and less than or equal to 1 mol % K₂O.

According to a forty-second aspect A42, a consumer electronic device comprises: a housing having a front surface, a back surface, and side surfaces; electrical components provided at least partially within the housing, the electrical components including at least a controller, a memory, and a display, the display being provided at or adjacent the front surface of the housing; and the glass article of any one of the twenty-seventh through forty-first aspects A27-A41 disposed over the display.

Additional features and advantages of the glass articles described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a cross-sectional, schematic view of a glass article having compressive stress regions, according to one or more embodiments described herein;

FIG. 2 is a plan view of an electronic device incorporating any of the glass articles according to one or more embodiments described herein; and

FIG. 3 is a perspective view of the electronic device of FIG. 2.

### DETAILED DESCRIPTION

Reference will now be made in detail to various embodiments of ion exchangeable glass articles having bendability, scratch resistance, and manufacturability.

According to embodiments, a glass article includes greater than or equal to 58 mol % and less than or equal to 75 mol % SiO₂; greater than or equal to 10 mol % and less than or equal to 20 mol % Al₂O₃; greater than or equal to 0 mol % and less than or equal to 8 mol % B₂O₃; greater than or equal to 0 mol % and less than or equal to 6 mol % P₂O₅; and greater than or equal to 10 mol % and less than or equal to 20 mol % Na₂O. B₂O₃+P₂O₅ may be greater than 0 mol % and less than or equal to 10 mol %. R₂O may be greater than or equal to 10 mol % and less than or equal to 20 mol %, wherein R₂O is the sum of Na₂O, Li₂O, and K₂O. R₂O—Al₂O₃ may be greater than or equal to 0 mol % and less than or equal to 10 mol %. RO may be greater than or equal to 0 mol % and less than or equal to 10 mol %, wherein RO is the sum of MgO, CaO, SrO, and ZnO. (R₂O+RO)—(Al₂O₃+B₂O₃) may be greater than or equal to −5 mol % and less than or equal to 10 mol %. The glass article may include a peak compressive stress (CS) and a Young's modulus (E), a ratio of the CS to the E being greater than or equal to 13, after the glass article is ion exchanged in a 100% KNO₃ salt bath at 410° C. for 30 minutes; a Knoop scratch threshold greater than 5 N; a zirconium breakdown temperature (T_{Zr}) and a 35 kP temperature (T₃₅ₖ), wherein a difference between the T_{Zr} and the T₃₅ₖ being greater than or equal to −35° C.; and a 200 P temperature (T₂₀₀) less than or equal to 1720° C.

Accordingly to embodiments, a glass article includes greater than or equal to 58 mol % and less than or equal to 68 mol % SiO₂; greater than or equal to 11 mol % and less than or equal to 15 mol % Al₂O₃; greater than or equal to 0 mol % and less than or equal to 7 mol % B₂O₃; greater than or equal to 0 mol % and less than or equal to 5 mol % P₂O₅; and greater than or equal to 13 mol % and less than or equal to 17 mol % Na₂O. B₂O₃+P₂O₅ may be greater than 1 mol % and less than or equal to 7 mol %. R₂O may be greater than or equal to 13 mol % and less than or equal to 17 mol %, wherein R₂O is the sum of Na₂O, Li₂O, and K₂O. R₂O—Al₂O₃ may be greater than or equal to 0 mol % and less than or equal to 3 mol %. RO may be greater than or equal to 2 mol % and less than or equal to 5 mol %, wherein RO is the sum of MgO, CaO, SrO, and ZnO. (R₂O+RO)—(Al₂O₃+B₂O₃) may be greater than or equal to −3 mol % and less than or equal to 6 mol %. The glass article may include a peak compressive stress (CS) and a Young's modulus (E), a ratio of the CS to the E being greater than or equal to 13, after the glass article is ion exchanged in a 100% KNO₃ salt bath at 410° C. for 30 minutes; a Knoop scratch threshold greater than 5 N; a zirconium breakdown temperature (T_{Zr}) and a 35 kP temperature (T₃₅ₖ), wherein a difference between the T_{Zr} and the T₃₅ₖ being greater than or equal to −35° C.; and a 200 P temperature (T₂₀₀) less than or equal to 1720° C.

Various embodiments of ion exchangeable glass articles will be described herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

In the embodiments of the glass articles described herein, the concentrations of constituent components (e.g., SiO₂, Al₂O₃, and the like) are specified in mole percent (mol %) on an oxide basis, unless otherwise specified.

The term “substantially free,” when used to describe the concentration and/or absence of a particular constituent component in a glass article, means that the constituent component is not intentionally added to the glass article. However, the glass article may contain traces of the constituent component as a contaminant or tramp in amounts of less than 0.05 weight percent (wt %). As noted herein, the remainder of the application specifies the concentrations of constituent component in mol %. The contaminant or tramp amounts of the constituent components are listed in wt % for manufacturing purposes and one skilled in the art would understand the contaminant and tramp amounts being listed in wt %.

The terms “0 mol %” and “free,” when used to describe the concentration and/or absence of a particular constituent component in a glass article, means that the constituent component is not present in the glass article.

The term “Vogel-Fulcher-Tamman (‘VFT’) relation,” as used herein, describes the temperature dependence of the viscosity and is represented by the following equation:

$$log η = A + \frac{B}{T - {T}_{o}}$$

where η is viscosity. To determine VFT A, VFT B, and VFT Tₒ, the viscosity of the glass composition is measured over a given temperature range. The raw data of viscosity versus temperature is then fit with the VFT equation by least-squares fitting to obtain A, B, and Tₒ. With these values, a viscosity point (e.g., 200 P Temperature (T₂₀₀) and 35 k P Temperature (T₃₅ₖ)) at any temperature above softening point may be calculated.

The terms “200 P Temperature” or “T₂₀₀,”, as used herein, refers to the temperature at which the glass article has a viscosity of 200 Poise (P).

The terms “35 k P Temperature” and “T₃₅ₖ,” as used herein, refers to the temperature at which the glass article has a viscosity of 35,000 P or 35 kiloPoise (kP).

The term “melting point,” as used herein, refers to the temperature at which the viscosity of the glass composition is 200 poise as measured in accordance with ASTM C338.

The term “softening point,” as used herein, refers to the temperature at which the viscosity of the glass composition is 1×10^{7.6} poise. The softening point is measured according to the parallel plate viscosity method which measures the viscosity of inorganic glass from 10⁷ to 10⁹ poise as a function of temperature, similar to ASTM C1351M.

The term “annealing point” or “effective annealing temperature” as used herein, refers to the temperature at which the viscosity of the glass composition is 1×10^{13.18} poise as measured in accordance with the fiber elongation method in accordance with ASTM C336, unless otherwise indicated.

The term “strain point,” as used herein, refers to the temperature at which the viscosity of the glass composition is 1×10^{14.68} poise as measured in accordance with ASTM C336, unless otherwise indicated.

The term “liquidus viscosity,” as used herein, refers to the viscosity of the glass composition at the onset of devitrification (i.e., at the liquidus temperature as determined with the gradient furnace method according to ASTM C829-81).

The elastic modulus (also referred to as Young's modulus) of the glass composition, as described herein, is provided in units of gigapascals (GPa) and is measured in accordance with ASTM C623.

Refractive index, as described herein, is measured in accordance with ASTM E1967.

The terms “zircon breakdown temperature” or “T_{Zr},” as used herein, refer to the temperature as which zircon, which may be used as a refractory material in glass processing and manufacture, breaks down to form zirconia and silica.

As used herein, the term “Knoop Scratch Threshold” refers to the onset of lateral cracking. In Knoop threshold testing, a mechanical tester holds a Knoop diamond in which a glass is scratched at increasing loads to determine the onset of lateral cracking. As used herein, Knoop Scratch Threshold is the onset of lateral cracking (in 3 or more of 5 indentation events). In Knoop Scratch Lateral Cracking Threshold testing, samples of the glass articles and articles were first scratched with a Knoop indenter under a dynamic or ramped load to identify the lateral crack onset load range for the sample population. Once the applicable load range is identified, a series of increasing constant load scratches (3 minimum or more per load) are performed to identify the Knoop scratch threshold. The Knoop scratch threshold range can be determined by comparing the test specimen to one of the following 3 failure modes: 1) sustained lateral surface cracks that are more than two times the width of the groove, 2) damage is contained within the groove, but there are lateral surface cracks that are less than two times the width of groove and there is damage visible by naked eye, or 3) the presence of large subsurface lateral cracks which are greater than two times the width of groove and/or there is a median crack at the vertex of the scratch.

As used herein, “peak compressive stress” refers to the highest compressive stress (CS) value measured within a compressive stress region. In embodiments, the peak compressive stress is located at the surface of the glass article. In other embodiments, the peak compressive stress may occur at a depth below the surface, giving the compressive stress profile the appearance of a “buried peak.” Unless specified otherwise, compressive stress (including surface CS) is measured by surface stress meter (FSM) using commercially available instruments, for example, the FSM-6000, manufactured by Orihara Industrial Co., Ltd. (Japan). Surface stress measurements rely upon the accurate measurement of the stress optical coefficient (SOC) which is related to the birefringence of the glass article. SOC in turn is measured according to Procedure C (Glass Disk Method) described in ASTM C770-16, entitled “Standard Test Method for measurement of Glass Stress-Optical Coefficient.” The maximum central tension (CT) values are measured using a Scattered Light Polariscope (SCALP), such as a SCALP-05 portable scattered light polariscope. The values reports for central tension (CT) herein refer to the maximum central tension, unless otherwise indicated.

According to the convention normally used in the art, compression or compressive stress (CS) is expressed as a negative (i.e., <0) stress and tension or tensile stress is expressed as a positive (i.e., >0) stress. Throughout this description, however, CS is expressed as a positive or absolute value (i.e., as recited herein, CS=|CS|).

As used herein, “depth of layer” (DOL) refers to the depth within a glass article at which an ion of metal oxide diffuses into the glass article where the concentration of the ion reaches a minimum value. In these embodiments, K⁺ ions are exchanged into the glass-based article. The depth of penetration of K⁺ ions (“Potassium DOL”) is distinguished from depth of compression (DOC, the point where the stress changes from positive to negative) because it represents the depth of potassium penetration as a result of an ion exchange process. The Potassium DOL is typically less than the DOC for the articles described herein. Potassium DOL is measured using a surface stress meter such as the commercially available FSM-6000 surface stress meter, manufactured by Orihara Industrial Co., Ltd. (Japan), which relies on accurate measurement of the stress optical coefficient (SOC), as described above with reference to the CS measurement.

Flexible versions of products and components that are traditionally rigid in nature are being conceptualized for new applications. For example, flexible electronic devices may provide thin, lightweight, and flexible properties that offer opportunities for new applications, for example, curved displays and wearable devices. Some of these electronic devices may also make use of flexible displays. Flexible displays should have resistance to failure at small bend radii, particularly for flexible displays that have touch screen functionality and/or may be folded.

Scratch resistance of conventional glass articles used for electronic devices may not be considered as conventional devices have customer facing surfaces protected by a layer(s) of polymer, which are susceptible to scratching (e.g., polyethylene terephthalate or 6-carboxypiperidine). Additionally, due to the feel of the polymer layer, as well as permanent or semi-permanent creasing, it may be desirable to not use a polymer layer as the customer facing surface and instead rely on a glass article.

Glass articles are generally more scratch resistant than articles having a polymer surface. Moreover, glass articles may be made more resistant to flexure failure through ion exchange processes, which involve inducing compressive stresses on the glass surfaces. The compressive stress introduced using an ion exchange process serves to, among other things, arrest flaws that can cause failure of the glass article. However, conventional glass articles may not provide both the desired bendability and scratch resistance while also being manufacturable.

Disclosed herein are glass articles which mitigate the aforementioned problems. Specifically, the glass articles disclosed herein comprise formulated concentrations of and relationships between constituents to achieve a desired bendability (e.g., a ratio of compressive stress to Young's modulus being greater than or equal to 13, after the glass article is ion exchanged in a 100% KNO₃ salt bath at 410° C. for 30 minutes), scratch resistance (e.g., a Knoop scratch threshold greater than 5 N), and manufacturability (e.g., a difference between a zirconium breakdown temperature and a 35 kP temperature greater than or equal to −35° C. and a 200 P temperature less than or equal to 1720° C.). B₂O₃ and P₂O₅ decrease Young's modulus, which helps to increase network flexibility, at the expense of a decreased compressive stress. Individually or in combination, B₂O₃ and P₂O₅ (i.e., B₂O₃+P₂O₅) improve scratch resistance. Al₂O₃ and R₂O (i.e., Na₂O, Li₂O, and K₂O) help to increase compressive stress, but need to be charge balanced against each other (e.g. R₂O—Al₂O₃ greater than or equal to 0 mol % and less than or equal to 10 mol %) to obtain a desirable bendability. RO also helps to improve compressive stress, but contributes to increasing Young's modulus and needs to be charged balanced, with R₂O, against Al₂O₃ and B₂O₃ (i.e., (R₂O+RO)—(Al₂O₃+B₂O₃) greater than or equal to −5 mol % and less than or equal to 10 mol %) to achieve a desirable scratch resistance. That is, improving bendability may reduce scratch resistance and vice versa. Manufacturability also should be considered. As such, there is a need for a new combination of balanced concentrations of constituents to achieve the combination of desired properties.

The glass articles described herein may be described as aluminosilicate glass articles and comprise SiO₂ and Al₂O₃. The glass articles described herein may further include B₂O₃ and/or P₂O₅. The glass articles described herein also include alkali oxides, such as Na₂O, to enable the ion exchangeability of the glass articles.

SiO₂ is the primary glass former in the glass articles described herein and may function to stabilize the network structure of the glass articles. The concentration of SiO₂ in the glass articles should be sufficiently high (e.g., greater than or equal to 58 mol %) to provide basic glass forming capability and chemical durability. The amount of SiO₂ may be limited (e.g., to less than or equal to 75 mol %) to control the melting point of the glass article and, thus, may aid in improving the meltability and the formability of the resulting glass article.

Accordingly, in embodiments, the glass article may comprise greater than or equal to 58 mol % and less than or equal to 75 mol % SiO₂. In embodiments, the glass article may comprise greater than or equal to 58 mol % and less than or equal to 68 mol % SiO₂. In embodiments, the concentration of SiO₂ in the glass article may be greater than or equal to 58 mol %, greater than or equal to 59, greater than or equal to 60 mol %, or even greater than or equal to 61 mol %. In embodiments, the concentration of SiO₂ in the glass article may be less than or equal to 75 mol %, less than or equal to 73 mol %, less than or equal to 70 mol %, less than or equal to 68 mol %, or even less than or equal to 65 mol %. In embodiments, the concentration of SiO₂ in the glass article may be greater than or equal to 58 mol % and less than or equal to 75 mol %, greater than or equal to 58 mol % and less than or equal to 73 mol %, greater than or equal to 58 mol % and less than or equal to 70 mol %, greater than or equal to 58 mol % and less than or equal to 68 mol %, greater than or equal to 58 mol % and less than or equal to 65 mol %, greater than or equal to 59 mol % and less than or equal to 75 mol %, greater than or equal to 59 mol % and less than or equal to 73 mol %, greater than or equal to 59 mol % and less than or equal to 70 mol %, greater than or equal to 59 mol % and less than or equal to 68 mol %, greater than or equal to 59 mol % and less than or equal to 65 mol %, greater than or equal to 60 mol % and less than or equal to 75 mol %, greater than or equal to 60 mol % and less than or equal to 73 mol %, greater than or equal to 60 mol % and less than or equal to 70 mol %, greater than or equal to 60 mol % and less than or equal to 68 mol %, greater than or equal to 60 mol % and less than or equal to 65 mol %, greater than or equal to 61 mol % and less than or equal to 75 mol %, greater than or equal to 61 mol % and less than or equal to 73 mol %, greater than or equal to 61 mol % and less than or equal to 70 mol %, greater than or equal to 61 mol % and less than or equal to 68 mol %, or even greater than or equal to 61 mol % and less than or equal to 65 mol %, or any and all sub-ranges formed from any of these endpoints.

Like SiO₂, Al₂O₃ may also stabilize the glass network and additionally provides improved mechanical properties, such as compressive stress and chemical durability to the glass article. The concentration of Al₂O₃ may also be tailored to the control the viscosity of the glass composition. Additionally, Al₂O₃ charge balances alkali oxides (i.e., Na₂O, Li₂O, and K₂O), such as Na₂O present in the glass article by forming sodium aluminate (NaAlO₂), thereby keeping boron in a three-coordinated state, which helps to reduce the Young's modulus and increase network flexibility. The concentration of Al₂O₃ should be sufficiently high (e.g., greater than or equal to 10 mol %) such that the glass has the desired bendability (e.g., a ratio of compressive stress to Young's modulus being greater than or equal to 13, after the glass article is ion exchanged in a 100% KNO₃ salt bath at 410° C. for 30 minutes). However, if the amount of Al₂O₃ is too high (e.g., greater than 20 mol %), the viscosity of the melt may increase, thereby diminishing the formability of the glass article.

Accordingly, in embodiments, the glass article may comprise greater than or equal to 10 mol % and less than or equal to 20 mol % Al₂O₃. In embodiments, the glass article may comprise greater than or equal to 11 mol % and less than or equal to 18 mol % Al₂O₃. In embodiments, the glass article may comprise greater than or equal to 11 mol % and less than or equal to 16 mol % Al₂O₃. In embodiments, the concentration of Al₂O₃ in the glass article may be greater than or equal to 10 mol %, greater than or equal to 11 mol %, or even greater than or equal to 12 mol %. In embodiments, the concentration of Al₂O₃ in the glass article may be less than or equal to 20 mol %, less than or equal to 18 mol %, less than or equal 16 mol %, less than or equal to 15 mol %, or even less than or equal to 14 mol %. In embodiments, the concentration of Al₂O₃ in the glass article may be greater than or equal to 10 mol % and less than or equal to 20 mol %, greater than or equal to 10 mol % and less than or equal to 18 mol %, greater than or equal to 10 mol % and less than or equal to 16 mol %, greater than or equal to 10 mol % and less than or equal to 15 mol %, greater than or equal to 10 mol % and less than or equal to 14 mol %, greater than or equal to 11 mol % and less than or equal to 20 mol %, greater than or equal to 11 mol % and less than or equal to 18 mol %, greater than or equal to 11 mol % and less than or equal to 16 mol %, greater than or equal to 11 mol % and less than or equal to 15 mol %, greater than or equal to 11 mol % and less than or equal to 14 mol %, greater than or equal to 12 mol % and less than or equal to 20 mol %, greater than or equal to 12 mol % and less than or equal to 18 mol %, greater than or equal to 12 mol % and less than or equal to 16 mol %, greater than or equal to 12 mol % and less than or equal to 15 mol %, or even greater than or equal to 12 mol % and less than or equal to 14 mol %, or any and all sub-ranges formed from any of these endpoints.

The glass articles described herein may further comprise B₂O₃ and/or P₂O₅ to improve scratch resistance. In embodiments, the sum of B₂O₃ and P₂O₅ (i.e., B₂O₃ (mol %)+P₂O₅ (mol %)) in the glass article may be greater than 0 mol % and less than or equal to 10 mol % to achieve a desired scratch resistance (e.g., a Knoop scratch threshold greater than 5 N). In embodiments, B₂O₃+P₂O₅ may be greater than or equal to 0.5 mol % and less than or equal to 8 mol %. In embodiments, B₂O₃+P₂O₅ may be greater than or equal to 1 mol % and less than or equal to 7 mol %. In embodiments, B₂O₃+P₂O₅ may be greater than 0 mol %, greater than or equal to 0.5 mol %, greater than or equal to 1 mol %, greater than or equal to 2 mol %, or even greater than or equal to 3 mol %. In embodiments, B₂O₃+P₂O₅ may be less than or equal to 10 mol %, less than or equal to 9 mol % less than or equal to 8 mol %, less than or equal to 7 mol %, less than or equal to 6 mol %, or even less than or equal to 5 mol %. In embodiments, B₂O₃+P₂O₅ may be greater than 0 mol % and less than or equal to 10 mol %, greater than 0 mol % and less than or equal to 9 mol %, greater than 0 mol % and less than or equal to 8 mol %, greater than 0 mol % and less than or equal to 7 mol %, greater than 0 mol % and less than or equal to 6 mol %, greater than 0 mol % and less than or equal to 5 mol %, greater than or equal to 0.5 mol % and less than or equal to 10 mol %, greater than or equal to 0.5 mol % and less than or equal to 9 mol %, greater than or equal to 0.5 mol % and less than or equal to 8 mol %, greater than or equal to 0.5 mol % and less than or equal to 7 mol %, greater than or equal to 0.5 mol % and less than or equal to 6 mol %, greater than or equal to 0.5 mol % and less than or equal to 5 mol %, greater than or equal to 1 mol % and less than or equal to 10 mol %, greater than or equal to 1 mol % and less than or equal to 9 mol %, greater than or equal to 1 mol % and less than or equal to 8 mol %, greater than or equal to 1 mol % and less than or equal to 7 mol %, greater than or equal to 1 mol % and less than or equal to 6 mol %, greater than or equal to 1 mol % and less than or equal to 5 mol %, greater than or equal to 2 mol % and less than or equal to 10 mol %, greater than or equal to 2 mol % and less than or equal to 9 mol %, greater than or equal to 2 mol % and less than or equal to 8 mol %, greater than or equal to 2 mol % and less than or equal to 7 mol %, greater than or equal to 2 mol % and less than or equal to 6 mol %, greater than or equal to 2 mol % and less than or equal to 5 mol %, greater than or equal to 3 mol % and less than or equal to 10 mol %, greater than or equal to 3 mol % and less than or equal to 9 mol %, greater than or equal to 3 mol % and less than or equal to 8 mol %, greater than or equal to 3 mol % and less than or equal to 7 mol %, greater than or equal to 3 mol % and less than or equal to 6 mol %, or even greater than or equal to 3 mol % and less than or equal to 5 mol %, or any and all sub-ranges formed from any of these endpoints.

B₂O₃ typically reduces compressive stress, but can improve scratch resistance when in the appropriate coordination state. Boron present in a silicate glass can be in the trigonal (3-fold) or tetragonal (4-fold) coordination state. Boron which is not coordinated by alkali oxides (such as Na₂O, Li₂O and K₂O) or divalent cation oxides (such as MgO, CaO, SrO, and ZnO), will be in a trigonal-coordinated state (or three-coordinated boron), which opens up the structure of the glass. Due to the planar nature of BO₃ the network around these three-coordinated boron atoms is not as rigid as tetrahedrally coordinated (or four-coordinated) boron. Without being bound by theory, it is believed that glass articles that include three-coordinated boron can tolerate some degree of deformation (e.g., plastic deformation) before crack formation compared to four-coordinated boron. By tolerating some deformation, Knoop scratch threshold values increase. As such, it may be desirable to have minimal “excess” modifier (e.g., alkali oxides and divalent cation oxides) available to coordinate with the boron, such that boron remains in its native 3-fold coordination state. For example, as described herein, Al₂O₃ present in the glass article may charge balance alkali oxides, thereby keeping boron in a three-coordinated state. B₂O₃ may also decrease the melting temperature of the glass article.

B₂O₃ may be present in the glass article (e.g., greater than or equal to 0.5 mol %) to achieve a desired scratch resistance (e.g., a Knoop scratch threshold greater than 5 N). However, if B₂O₃ is too high, compressive stress may be undesirably reduced. Moreover, the chemical durability and liquidus viscosity may diminish and volatilization and evaporation of B₂O₃ during melting becomes difficult to control. Therefore, the amount of B₂O₃ may be limited (e.g., less than or equal to 8 mol %) to achieve a desired bendability (e.g., (e.g., a ratio of compressive stress to Young's modulus being greater than or equal to 13, after the glass article is ion exchanged in a 100% KNO₃ salt bath at 410° C. for 30 minutes) and to maintain chemical durability of the glass article.

Accordingly, in embodiments, the glass article may comprise greater than or equal to 0 mol % and less than or equal to 8 mol % B₂O₃. In embodiments, the glass article may comprise greater than or equal to 0.5 mol % and less than or equal to 7 mol % B₂O₃. In embodiments, the glass article may comprise greater than or equal to 0 mol % and less than or equal to 7 mol % B₂O₃. In embodiments, the concentration of B₂O₃ in the glass article may be greater than or equal to 0 mol %, greater than or equal to 0.5 mol %, greater than or equal to 1 mol %, greater than or equal to 2 mol %, or even greater than or equal to 3 mol %. In embodiments, the concentration of B₂O₃ in the glass article may be less than or equal to 8 mol %, less than or equal to 7 mol %, less than or equal to 6 mol %, less than or equal to 5 mol % or even less than or equal to 4 mol %. In embodiments, the concentration of B₂O₃ in the glass article may be greater than or equal to 0 mol % and less than or equal to 8 mol %, greater than or equal to 0 mol % and less than or equal to 7 mol %, greater than or equal to 0 mol % and less than or equal to 6 mol %, greater than or equal to 0 mol % and less than or equal to 5 mol %, greater than or equal to 0 mol % and less than or equal to 4 mol %, greater than or equal to 0.5 mol % and less than or equal to 8 mol %, greater than or equal to 0.5 mol % and less than or equal to 7 mol %, greater than or equal to 0.5 mol % and less than or equal to 6 mol %, greater than or equal to 0.5 mol % and less than or equal to 5 mol %, greater than or equal to 0.5 mol % and less than or equal to 4 mol %, greater than or equal to 1 mol % and less than or equal to 8 mol %, greater than or equal to 1 mol % and less than or equal to 7 mol %, greater than or equal to 1 mol % and less than or equal to 6 mol %, greater than or equal to 1 mol % and less than or equal to 5 mol %, greater than or equal to 1 mol % and less than or equal to 4 mol %, greater than or equal to 2 mol % and less than or equal to 8 mol %, greater than or equal to 2 mol % and less than or equal to 7 mol %, greater than or equal to 2 mol % and less than or equal to 6 mol %, greater than or equal to 2 mol % and less than or equal to 5 mol %, greater than or equal to 2 mol % and less than or equal to 4 mol %, greater than or equal to 3 mol % and less than or equal to 8 mol %, greater than or equal to 3 mol % and less than or equal to 7 mol %, greater than or equal to 3 mol % and less than or equal to 6 mol %, greater than or equal to 3 mol % and less than or equal to 5 mol %, or even greater than or equal to 3 mol % and less than or equal to 4 mol %, or any and all sub-ranges formed from any of these endpoints. In embodiments, the glass article may be free or substantially free of B₂O₃.

The glass articles described herein may further comprise P₂O₅. In addition to improving scratch resistance, P₂O₅ may decrease the Young's modulus of the glass article, which helps to increase network flexibility. P₂O₅ may also lower the melting and liquidus temperatures and may increase inter-ionic diffusivity such that the time required for ion exchange is reduced. The amount of P₂O₅ in the glass composition may be limited (e.g., less than or equal to 6 mol %) to prevent undesirable phase separation and reduce the amount of phosphoric acid released during melting. In embodiments, the glass article may comprise greater than or equal to 0 mol % and less than or equal to 6 mol % P₂O₅. In embodiments, the glass article may comprise greater than or equal to 0.5 mol % and less than or equal to 5 mol % P₂O₅. In embodiments, the glass article may comprise greater than or equal to 0 mol % and less than or equal to 5 mol % P₂O₅. In embodiments, the concentration of P₂O₅ in the glass article may be greater than or equal to 0 mol %, greater than or equal to 0.5 mol %, greater than or equal to 1 mol %, or even greater than or equal to 2 mol %. In embodiments, the concentration of P₂O₅ in the glass article may be less than or equal to 6 mol %, less than or equal to 5 mol %, or even less than or equal to 4 mol %. In embodiments, the concentration of P₂O₅ in the glass article may be greater than or equal to 0 mol % and less than or equal to 6 mol %, greater than or equal to 0 mol % and less than or equal to 5 mol %, greater than or equal to 0 mol % and less than or equal to 4 mol %, greater than or equal to 0.5 mol % and less than or equal to 6 mol %, greater than or equal to 0.5 mol % and less than or equal to 5 mol %, greater than or equal to 0.5 mol % and less than or equal to 4 mol %, greater than or equal to 1 mol % and less than or equal to 6 mol %, greater than or equal to 1 mol % and less than or equal to 5 mol %, greater than or equal to 1 mol % and less than or equal to 4 mol %, greater than or equal to 2 mol % and less than or equal to 6 mol %, greater than or equal to 2 mol % and less than or equal to 5 mol %, or even greater than or equal to 2 mol % and less than or equal to 4 mol %, or any and all sub-ranges formed from any of these endpoints. In embodiments, the glass article may be free or substantially free of P₂O₅.

As described hereinabove, the glass articles may contain alkali oxides, such as Na₂O, to enable the ion exchangeability of the glass articles.

Na₂O aids in the ion exchangeability of the glass article, which helps to increase compressive stress. Na₂O also reduces the softening point of the glass article thereby increasing the formability of the glass. However, if too much Na₂O is added to the glass article, the melting point may be too low. In embodiments, the glass article may comprise greater than or equal to 10 mol % and less than or equal to 20 mol % Na₂O. In embodiments, the glass article may comprise greater than or equal to 12 mol % and less than or equal to 18 mol % Na₂O. In embodiments, the glass article may comprise greater than or equal to 13 mol % and less than or equal to 17 mol % Na₂O. In embodiments, the concentration of Na₂O in the glass article may be greater than or equal to 10 mol %, greater than or equal to 11 mol %, greater than or equal to 12 mol %, greater than or equal to 13 mol %, or even greater than or equal to 14 mol %. In embodiments, the concentration of Na₂O in the glass article may be less than or equal to 20 mol %, less than or equal to 19 mol %, less than or equal to 18 mol %, less than or equal to 17 mol % or even less than or equal to 16 mol %. In embodiments, the concentration of Na₂O in the glass article may be greater than or equal to 10 mol % and less than or equal to 20 mol %, greater than or equal to 10 mol % and less than or equal to 19 mol %, greater than or equal to 10 mol % and less than or equal to 18 mol %, greater than or equal to 10 mol % and less than or equal to 17 mol %, greater than or equal to 10 mol % and less than or equal to 16 mol %, greater than or equal to 11 mol % and less than or equal to 20 mol %, greater than or equal to 11 mol % and less than or equal to 19 mol %, greater than or equal to 11 mol % and less than or equal to 18 mol %, greater than or equal to 11 mol % and less than or equal to 17 mol %, greater than or equal to 11 mol % and less than or equal to 16 mol %, greater than or equal to 12 mol % and less than or equal to 20 mol %, greater than or equal to 12 mol % and less than or equal to 19 mol %, greater than or equal to 12 mol % and less than or equal to 18 mol %, greater than or equal to 12 mol % and less than or equal to 17 mol %, greater than or equal to 12 mol % and less than or equal to 16 mol %, greater than or equal to 13 mol % and less than or equal to 20 mol %, greater than or equal to 13 mol % and less than or equal to 19 mol %, greater than or equal to 13 mol % and less than or equal to 18 mol %, greater than or equal to 13 mol % and less than or equal to 17 mol %, greater than or equal to 13 mol % and less than or equal to 16 mol %, greater than or equal to 14 mol % and less than or equal to 20 mol %, greater than or equal to 14 mol % and less than or equal to 19 mol %, greater than or equal to 14 mol % and less than or equal to 18 mol %, greater than or equal to 14 mol % and less than or equal to 17 mol %, or even greater than or equal to 14 mol % and less than or equal to 16 mol %, or any and all sub-ranges formed from any of these endpoints.

The glass articles described herein may further comprise alkali metal oxides other than Na₂O, such as Li₂O and K₂O. In addition to aiding in ion exchangeability of the glass composition, Li₂O, when included, decreases the melting point and improves formability of the glass composition. In embodiments, the glass article may comprise greater than 0 mol % and less than or equal to 5 mol % Li₂O. In embodiments, the glass article may comprise greater than 0 mol % and less than or equal to 3 mol % Li₂O. In embodiments, the concentration of Li₂O in the glass article may be greater than or equal to 0 mol %, greater than or equal to 0.5 mol %, or even greater than or equal to 1 mol %. In embodiments, the concentration of Li₂O in the glass article may be less than or equal to 5 mol %, less than or equal to 4 mol %, less than or equal to 3 mol %, or even less than or equal to 2 mol %. In embodiments, the concentration of Li₂O in the glass article may be greater than or equal to 0 mol % and less than or equal to 5 mol %, greater than or equal to 0 mol % and less than or equal to 4 mol %, greater than or equal to 0 mol % and less than or equal to 3 mol %, greater than or equal to 0 mol % and less than or equal to 2 mol %, greater than or equal to 0.5 mol % and less than or equal to 5 mol %, greater than or equal to 0.5 mol % and less than or equal to 4 mol %, greater than or equal to 0.5 mol % and less than or equal to 3 mol %, greater than or equal to 0.5 mol % and less than or equal to 2 mol %, greater than or equal to 1 mol % and less than or equal to 5 mol %, greater than or equal to 1 mol % and less than or equal to 4 mol %, greater than or equal to 1 mol % and less than or equal to 3 mol %, or even greater than or equal to 1 mol % and less than or equal to 2 mol %, or any and all sub-ranges formed from any of these endpoints. In embodiments, the glass article may be free or substantially free of Li₂O.

K₂O, when included, promotes ion exchange and may increase the depth of compression and decrease the melting point to improve the formability of the glass composition. However, adding too much K₂O may cause the surface compressive stress and melting point to be too low. Accordingly, in embodiments, the amount of K₂O added to the glass composition may be limited. In embodiments, the glass article may comprise greater than 0 mol % and less than or equal to 5 mol % K₂O. In embodiments, the glass article may comprise greater than 0 mol % and less than or equal to 3 mol % K₂O. In embodiments, the concentration of K₂O in the glass article may be greater than or equal to 0 mol %, greater than or equal to 0.01 mol %, greater than or equal to 0.1 mol %, or even greater than or equal to 0.25 mol %. In embodiments, the concentration of K₂O in the glass article may be less than or equal to 5 mol %, less than or equal to 3 mol %, less than or equal to 1 mol %, or even less than or equal to 0.5 mol %. In embodiments, the concentration of K₂O in the glass article may be greater than or equal to 0 mol % and less than or equal to 5 mol %, greater than or equal to 0 mol % and less than or equal to 3 mol %, greater than or equal to 0 mol % and less than or equal to 1 mol %, greater than or equal to 0 mol % and less than or equal to 0.5 mol %, greater than or equal to 0.01 mol % and less than or equal to 5 mol %, greater than or equal to 0.01 mol % and less than or equal to 3 mol %, greater than or equal to 0.01 mol % and less than or equal to 1 mol %, greater than or equal to 0.01 mol % and less than or equal to 0.5 mol %, greater than or equal to 0.1 mol % and less than or equal to 5 mol %, greater than or equal to 0.1 mol % and less than or equal to 3 mol %, greater than or equal to 0.1 mol % and less than or equal to 1 mol %, greater than or equal to 0.1 mol % and less than or equal to 0.5 mol %, greater than or equal to 0.25 mol % and less than or equal to 5 mol %, greater than or equal to 0.25 mol % and less than or equal to 3 mol %, greater than or equal to 0.25 mol % and less than or equal to 1 mol %, or even greater than or equal to 0.25 mol % and less than or equal to 0.5 mol %, or any and all sub-ranges formed from any of these endpoints. In embodiments, the glass article may be free or substantially free of K₂O.

As used herein, R₂O is the sum (in mol %) of Na₂O, K₂O, and Li₂O (i.e., R₂O=Na₂O (mol %)+K₂O (mol %)+Li₂O (mol %) present in the glass articles. Alkali oxides, such as Na₂O, K₂O, and Li₂O, aid in the ion exchangeability of the glass article, which may help to increase compressive stress. Alkali oxides may also aid in decreasing the softening point and molding temperature of the glass article, thereby offsetting the increase in the softening point and molding temperature of the glass article due to higher amounts of SiO₂ in the glass article, for example. The decrease in the softening point and molding temperature may be further reduced by including combinations of alkali oxides (e.g., two or more alkali oxides) in the glass article, a phenomenon referred to as the “mixed alkali effect.” However, it has been found that if the amount of alkali oxide is too high, the average coefficient of thermal expansion of the glass article increases to greater than 100×10⁻⁷/° C., which may be undesirable.

In embodiments, R₂O in the glass article may be greater than or equal to 10 mol % and less than or equal to 20 mol %. In embodiments, R₂O in the glass article may be greater than or equal to 12 mol % and less than or equal to 18 mol %. In embodiments, R₂O in the glass article may be greater than or equal to 13 mol % and less than or equal to 17 mol %. In embodiments, R₂O in the glass article may be greater than or equal to 10 mol %, greater than or equal to 11 mol %, greater than or equal to 12 mol %, greater than or equal to 13 mol %, or even greater than or equal to 14 mol %. In embodiments, R₂O in the glass article may be less than or equal to 20 mol %, less than or equal to 19 mol %, less than or equal to 18 mol %, less than or equal to 17 mol %, or even less than or equal to 16 mol %. In embodiments, R₂O in the glass article may be greater than or equal to 10 mol % and less than or equal to 20 mol %, greater than or equal to 10 mol % and less than or equal to 19 mol %, greater than or equal to 10 mol % and less than or equal to 18 mol %, greater than or equal to 10 mol % and less than or equal to 17 mol %, greater than or equal to 10 mol % and less than or equal to 16 mol %, greater than or equal to 11 mol % and less than or equal to 20 mol %, greater than or equal to 11 mol % and less than or equal to 19 mol %, greater than or equal to 11 mol % and less than or equal to 18 mol %, greater than or equal to 11 mol % and less than or equal to 17 mol %, greater than or equal to 11 mol % and less than or equal to 16 mol %, greater than or equal to 12 mol % and less than or equal to 20 mol %, greater than or equal to 12 mol % and less than or equal to 19 mol %, greater than or equal to 12 mol % and less than or equal to 18 mol %, greater than or equal to 12 mol % and less than or equal to 17 mol %, greater than or equal to 12 mol % and less than or equal to 16 mol %, greater than or equal to 13 mol % and less than or equal to 20 mol %, greater than or equal to 13 mol % and less than or equal to 19 mol %, greater than or equal to 13 mol % and less than or equal to 18 mol %, greater than or equal to 13 mol % and less than or equal to 17 mol %, greater than or equal to 13 mol % and less than or equal to 16 mol %, greater than or equal to 14 mol % and less than or equal to 20 mol %, greater than or equal to 14 mol % and less than or equal to 19 mol %, greater than or equal to 14 mol % and less than or equal to 18 mol %, greater than or equal to 14 mol % and less than or equal to 17 mol %, or even greater than or equal to 14 mol % and less than or equal to 16 mol %, or any and all sub-ranges formed from any of these endpoints.

Al₂O₃ and R₂O may be charge balanced against each other (e.g. R₂O—Al₂O₃ greater than or equal to 0 mol % and less than or equal to 10 mol %) to obtain a desirable bendability (e.g., a ratio of compressive stress to Young's modulus being greater than or equal to 13, after the glass article is ion exchanged in a 100% KNO₃ salt bath at 410° C. for 30 minutes). In embodiments, a difference (in mol %) between R₂O and Al₂O₃ and (i.e., R₂O (mol %)−Al₂O₃ (mol %)) in the glass article may be greater than or equal to 0 mol % and less than or equal to 10 mol %. In embodiments, R₂O—Al₂O₃ in the glass article may be greater than or equal to 0.5 mol % and less than or equal to 6 mol %. In embodiments, R₂O—Al₂O₃ in the glass article may be greater than or equal to 0 mol % and less than or equal to 4 mol %. In embodiments, R₂O—Al₂O₃ in the glass article may be greater than or equal to 0 mol %, greater than or equal to 0.1 mol %, greater than or equal to 0.5 mol %, or even greater than or equal to 1 mol %. In embodiments, R₂O—Al₂O₃ in the glass article may be less than or equal to 10 mol %, less than or equal to 8 mol %, less than or equal to 6 mol %, less than or equal to 4 mol %, or even less than or equal to 2 mol %. In embodiments, R₂O—Al₂O₃ in the glass article may be greater than or equal to 0 mol % and less than or equal to 10 mol %, greater than or equal to 0 mol % and less than or equal to 8 mol %, greater than or equal to 0 mol % and less than or equal to 6 mol %, greater than or equal to 0 mol % and less than or equal to 4 mol %, greater than or equal to 0 mol % and less than or equal to 2 mol %, greater than or equal to 0.1 mol % and less than or equal to 10 mol %, greater than or equal to 0.1 mol % and less than or equal to 8 mol %, greater than or equal to 0.1 mol % and less than or equal to 6 mol %, greater than or equal to 0.1 mol % and less than or equal to 4 mol %, greater than or equal to 0.1 mol % and less than or equal to 2 mol %, greater than or equal to 0.5 mol % and less than or equal to 10 mol %, greater than or equal to 0.5 mol % and less than or equal to 8 mol %, greater than or equal to 0.5 mol % and less than or equal to 6 mol %, greater than or equal to 0.5 mol % and less than or equal to 4 mol %, greater than or equal to 0.5 mol % and less than or equal to 2 mol %, greater than or equal to 1 mol % and less than or equal to 10 mol %, greater than or equal to 1 mol % and less than or equal to 8 mol %, greater than or equal to 1 mol % and less than or equal to 6 mol %, greater than or equal to 1 mol % and less than or equal to 4 mol %, or even greater than or equal to 1 mol % and less than or equal to 2 mol %, or any and all sub-ranges formed from any of these endpoints.

In embodiments, the glass articles described herein may further comprise divalent cation oxides, such as MgO, CaO, SrO, and ZnO. Divalent cation oxides help to improve compressive stress, but contribute to increasing Young's modulus and need to be charged balanced, with R₂O, against Al₂O₃ and B₂O₃ (i.e., (R₂O+RO)—(Al₂O₃+B₂O₃) greater than or equal to −5 mol % and less than or equal to 10 mol %) to achieve a desirable scratch resistance (e.g., a Knoop scratch threshold greater than 5 N).

As used herein, RO is the sum (in mol %) of MgO, CaO, SrO, and ZnO (i.e., RO=MgO (mol %)+CaO (mol %)+SrO (mol %)+ZnO (mol %)) present in the glass articles. In embodiments, RO in the glass article may be greater than or equal to 0 mol % and less than or equal to 10 mol %. In embodiments, RO in the glass article may be greater than or equal to 1 mol % and less than or equal to 6 mol %. In embodiments, RO in the glass article may be greater than or equal to 2 mol % and less than or equal to 5 mol %. In embodiments, RO in the glass article may be greater than or equal to 0 mol %, greater than or equal to 1 mol %, greater than or equal to 2 mol %, or even greater than or equal to 3 mol %. In embodiments, RO in the glass article may be less than or equal to 10 mol %, less than or equal to 8 mol %, less than or equal to 6 mol %, less than or equal to 5 mol %, or even less than or equal to 4 mol %. In embodiments, RO in the glass article may be greater than or equal to 0 mol % and less than or equal to 10 mol %, greater than or equal to 0 mol % and less than or equal to 8 mol %, greater than or equal to 0 mol % and less than or equal to 6 mol %, greater than or equal to 0 mol % and less than or equal to 5 mol %, greater than or equal to 0 mol % and less than or equal to 4 mol %, greater than or equal to 1 mol % and less than or equal to 10 mol %, greater than or equal to 1 mol % and less than or equal to 8 mol %, greater than or equal to 1 mol % and less than or equal to 6 mol %, greater than or equal to 1 mol % and less than or equal to 5 mol %, greater than or equal to 1 mol % and less than or equal to 4 mol %, greater than or equal to 2 mol % and less than or equal to 10 mol %, greater than or equal to 2 mol % and less than or equal to 8 mol %, greater than or equal to 2 mol % and less than or equal to 6 mol %, greater than or equal to 2 mol % and less than or equal to 5 mol %, greater than or equal to 2 mol % and less than or equal to 4 mol %, greater than or equal to 3 mol % and less than or equal to 10 mol %, greater than or equal to 3 mol % and less than or equal to 8 mol %, greater than or equal to 3 mol % and less than or equal to 6 mol %, greater than or equal to 3 mol % and less than or equal to 5 mol %, or even greater than or equal to 3 mol % and less than or equal to 4 mol %, or any and all sub-ranges formed from any of these endpoints. In embodiments, the glass article may be free or substantially free of RO.

In embodiments, the glass article may comprise greater than 0 mol % and less than or equal to 7 mol % MgO. In embodiments, the glass article may comprise greater than or equal to 1 mol % and less than or equal to 5 mol % MgO. In embodiments, the concentration of MgO in the glass article may be greater than or equal to 0 mol %, greater than or equal to 0.5 mol %, or even greater than or equal to 1 mol %. In embodiments, the concentration of MgO in the glass article may be less than or equal to 7 mol %, less than or equal to 5 mol %, less than or equal to 3 mol %, or even less than or equal to 1 mol %. In embodiments, the concentration of MgO in the glass article may be greater than or equal to 0 mol % and less than or equal to 7 mol %, greater than or equal to 0 mol % and less than or equal to 5 mol %, greater than or equal to 0 mol % and less than or equal to 3 mol %, greater than or equal to 0 mol % and less than or equal to 1 mol %, greater than or equal to 0.5 mol % and less than or equal to 7 mol %, greater than or equal to 0.5 mol % and less than or equal to 5 mol %, greater than or equal to 0.5 mol % and less than or equal to 3 mol %, greater than or equal to 0.5 mol % and less than or equal to 1 mol %, greater than or equal to 1 mol % and less than or equal to 7 mol %, greater than or equal to 1 mol % and less than or equal to 5 mol %, or even greater than or equal to 1 mol % and less than or equal to 3 mol %, or any and all sub-ranges formed from any of these endpoints. In embodiments, the glass article may be free or substantially free of MgO.

In embodiments, the glass article may comprise greater than 0 mol % and less than or equal to 5 mol % CaO. In embodiments, the glass article may comprise greater than 0 mol % and less than or equal to 1 mol % CaO. In embodiments, the concentration of CaO in the glass article may be greater than or equal to 0 mol %, greater than or equal to 0.01 mol %, or even greater than or equal to 0.1 mol %. In embodiments, the concentration of CaO in the glass article may be less than or equal to 5 mol %, less than or equal to 3 mol %, less than or equal to 1 mol %, or even less than or equal to 0.5 mol %. In embodiments, the concentration of CaO in the glass article may be greater than or equal to 0 mol % and less than or equal to 5 mol %, greater than or equal to 0 mol % and less than or equal to 3 mol %, greater than or equal to 0 mol % and less than or equal to 1 mol %, greater than or equal to 0 mol % and less than or equal to 0.5 mol %, greater than or equal to 0.01 mol % and less than or equal to 5 mol %, greater than or equal to 0.01 mol % and less than or equal to 3 mol %, greater than or equal to 0.01 mol % and less than or equal to 1 mol %, greater than or equal to 0.01 mol % and less than or equal to 0.5 mol %, greater than or equal to 0.1 mol % and less than or equal to 5 mol %, greater than or equal to 0.1 mol % and less than or equal to 3 mol %, greater than or equal to 0.1 mol % and less than or equal to 1 mol %, or even greater than or equal to 0.1 mol % and less than or equal to 0.5 mol %, or any and all sub-ranges formed from any of these endpoints. In embodiments, the glass article may be free or substantially free of CaO.

In embodiments, the glass article may comprise greater than 0 mol % and less than or equal to 5 mol % SrO. In embodiments, the glass article may comprise greater than 0 mol % and less than or equal to 3 mol % SrO. In embodiments, the concentration of SrO in the glass article may be greater than or equal to 0 mol %, greater than or equal to 0.01 mol %, or even greater than or equal to 0.1 mol %. In embodiments, the concentration of SrO in the glass article may be less than or equal to 5 mol %, less than or equal to 3 mol %, less than or equal to 1 mol %, or even less than or equal to 0.5 mol %. In embodiments, the concentration of SrO in the glass article may be greater than or equal to 0 mol % and less than or equal to 5 mol %, greater than or equal to 0 mol % and less than or equal to 3 mol %, greater than or equal to 0 mol % and less than or equal to 1 mol %, greater than or equal to 0 mol % and less than or equal to 0.5 mol %, greater than or equal to 0.01 mol % and less than or equal to 5 mol %, greater than or equal to 0.01 mol % and less than or equal to 3 mol %, greater than or equal to 0.01 mol % and less than or equal to 1 mol %, greater than or equal to 0.01 mol % and less than or equal to 0.5 mol %, greater than or equal to 0.1 mol % and less than or equal to 5 mol %, greater than or equal to 0.1 mol % and less than or equal to 3 mol %, greater than or equal to 0.1 mol % and less than or equal to 1 mol %, or even greater than or equal to 0.1 mol % and less than or equal to 0.5 mol %, or any and all sub-ranges formed from any of these endpoints. In embodiments, the glass article may be free or substantially free of SrO.

In embodiments, the glass article may comprise greater than 0 mol % and less than or equal to 5 mol % ZnO. In embodiments, the glass article may comprise greater than 0 mol % and less than or equal to 2 mol % ZnO. In embodiments, the concentration of ZnO in the glass article may be greater than or equal to 0 mol %, greater than or equal to 0.1 mol %, or even greater than or equal to 0.5 mol %. In embodiments, the concentration of ZnO in the glass article may be less than or equal to 5 mol %, less than or equal to 4 mol %, less than or equal to 3 mol %, less than or equal to 2 mol %, or even less than or equal to 1 mol %. In embodiments, the concentration of ZnO in the glass article may be greater than or equal to 0 mol % and less than or equal to 5 mol %, greater than or equal to 0 mol % and less than or equal to 4 mol %, greater than or equal to 0 mol % and less than or equal to 3 mol %, greater than or equal to 0 mol % and less than or equal to 2 mol %, greater than or equal to 0 mol % and less than or equal to 1 mol %, greater than or equal to 0.1 mol % and less than or equal to 5 mol %, greater than or equal to 0.1 mol % and less than or equal to 4 mol %, greater than or equal to 0.1 mol % and less than or equal to 3 mol %, greater than or equal to 0.1 mol % and less than or equal to 2 mol %, greater than or equal to 0.1 mol % and less than or equal to 1 mol %, greater than or equal to 0.5 mol % and less than or equal to 5 mol %, greater than or equal to 0.5 mol % and less than or equal to 4 mol %, greater than or equal to 0.5 mol % and less than or equal to 3 mol %, greater than or equal to 0.5 mol % and less than or equal to 2 mol %, or even greater than or equal to 0.5 mol % and less than or equal to 1 mol %, or any and all sub-ranges formed from any of these endpoints.

In embodiments, a sum (in mol %) of R₂O and RO (i.e., R₂O (mol %)+RO (mol %)) in the glass article may be greater than or equal to 10 mol %, greater than or equal to 12 mol %, great than or equal to 14 mol %, or even greater than or equal to 16 mol %. In embodiments R₂O+RO in the glass article may be less than or equal to 30 mol %, less than or equal to 28 mol %, less than or equal to 26 mol %, less than or equal to 24 mol %, less than or equal to 22 mol %, or even less than or equal to 20 mol %. In embodiments, R₂O+RO in the glass article may be greater than or equal to 10 mol % and less than or equal to 30 mol %, greater than or equal to 10 mol % and less than or equal to 28 mol %, greater than or equal to 10 mol % and less than or equal to 26 mol %, greater than or equal to 10 mol % and less than or equal to 24 mol %, greater than or equal to 10 mol % and less than or equal to 22 mol %, greater than or equal to 10 mol % and less than or equal to 20 mol %, greater than or equal to 12 mol % and less than or equal to 30 mol %, greater than or equal to 12 mol % and less than or equal to 28 mol %, greater than or equal to 12 mol % and less than or equal to 26 mol %, greater than or equal to 12 mol % and less than or equal to 24 mol %, greater than or equal to 12 mol % and less than or equal to 22 mol %, greater than or equal to 12 mol % and less than or equal to 20 mol %, greater than or equal to 14 mol % and less than or equal to 30 mol %, greater than or equal to 14 mol % and less than or equal to 28 mol %, greater than or equal to 14 mol % and less than or equal to 26 mol %, greater than or equal to 14 mol % and less than or equal to 24 mol %, greater than or equal to 14 mol % and less than or equal to 22 mol %, greater than or equal to 14 mol % and less than or equal to 20 mol %, greater than or equal to 16 mol % and less than or equal to 30 mol %, greater than or equal to 16 mol % and less than or equal to 28 mol %, greater than or equal to 16 mol % and less than or equal to 26 mol %, greater than or equal to 16 mol % and less than or equal to 24 mol %, greater than or equal to 16 mol % and less than or equal to 22 mol %, or even greater than or equal to 16 mol % and less than or equal to 20 mol %, or any and all sub-ranges formed from any of these endpoints.

As described herein, R₂O and RO may be charged balanced against Al₂O₃ and B₂O₃ such that the boron is in a trigonal-coordinated state, thereby leading to a desirable scratch resistance (e.g., a Knoop scratch threshold greater than 5 N). In embodiments, a difference (in mol %) between the sum of R₂O and RO and the sum of Al₂O₃ and B₂O₃ (i.e., (R₂O (mol %)+RO (mol %))−(Al₂O₃ (mol %)+B₂O₃ (mol %)) in the glass article may be greater than or equal to −5 mol % and less than or equal to 10 mol %. In embodiments, (R₂O+RO)—(Al₂O₃+B₂O₃) in the glass article may be greater than or equal to −3 mol % and less than or equal to 9 mol %. In embodiments, (R₂O+RO)—(Al₂O₃+B₂O₃) in the glass article may be greater than or equal to −3 mol % and less than or equal to 7 mol %. In embodiments, (R₂O+RO)—(Al₂O₃+B₂O₃) in the glass article may be greater than or equal to −5 mol %, greater than or equal to −4 mol %, greater than or equal to −3 mol %, greater than −2 mol % or even greater than or equal to −1 mol %. In embodiments, (R₂O+RO)—(Al₂O₃+B₂O₃) in the glass article may be less than or equal to 10 mol %, less than or equal to 9 mol %, less than or equal to 7 mol %, less than or equal to 5 mol %, less than or equal to 3 mol %, or even less than or equal to 1 mol %. In embodiments, (R₂O+RO)—(Al₂O₃+B₂O₃) in the glass article may be greater than or equal to −5 mol % and less than or equal to 10 mol %, greater than or equal to −5 mol % and less than or equal to 9 mol %, greater than or equal to −5 mol % and less than or equal to 7 mol %, greater than or equal to −5 mol % and less than or equal to 5 mol %, greater than or equal to −5 mol % and less than or equal to 3 mol %, greater than or equal to −5 mol % and less than or equal to 1 mol %, greater than or equal to −4 mol % and less than or equal to 10 mol %, greater than or equal to −4 mol % and less than or equal to 9 mol %, greater than or equal to −4 mol % and less than or equal to 7 mol %, greater than or equal to −4 mol % and less than or equal to 5 mol %, greater than or equal to −4 mol % and less than or equal to 3 mol %, greater than or equal to −4 mol % and less than or equal to 1 mol %, greater than or equal to −3 mol % and less than or equal to 10 mol %, greater than or equal to −3 mol % and less than or equal to 9 mol %, greater than or equal to −3 mol % and less than or equal to 7 mol %, greater than or equal to −3 mol % and less than or equal to 5 mol %, greater than or equal to −3 mol % and less than or equal to 3 mol %, greater than or equal to −3 mol % and less than or equal to 1 mol %, greater than or equal to −2 mol % and less than or equal to 10 mol %, greater than or equal to −2 mol % and less than or equal to 9 mol %, greater than or equal to −2 mol % and less than or equal to 7 mol %, greater than or equal to −2 mol % and less than or equal to 5 mol %, greater than or equal to −2 mol % and less than or equal to 3 mol %, greater than or equal to −2 mol % and less than or equal to 1 mol %, greater than or equal to −1 mol % and less than or equal to 10 mol %, greater than or equal to −1 mol % and less than or equal to 9 mol %, greater than or equal to −1 mol % and less than or equal to 7 mol %, greater than or equal to −1 mol % and less than or equal to 5 mol %, greater than or equal to −1 mol % and less than or equal to 3 mol %, or even greater than or equal to −1 mol % and less than or equal to 1 mol %, or any and all sub-ranges formed from any of these endpoints.

In embodiments, the glass articles described herein may further include one or more fining agents. In embodiments, the fining agents may include, for example, SnO₂. In embodiments, the concentration of SnO₂ in the glass article may be greater than or equal to 0 mol % and less than or equal to 0.5 mol % or even greater than or equal to 0 mol % and less than or equal to 0.25 mol %. In embodiments, the glass article may be free or substantially free of SnO₂.

In embodiments, the glass articles described herein may further include tramp materials such as TiO₂, Fe₂O₃, MnO, MoO₃, WO₃, Y₂O₃, CdO, As₂O₃, Sb₂O₃, sulfur-based compounds, such as sulfates, halogens, or combinations thereof. In embodiments, the glass articles may be free or substantially free of individual tramp materials, a combination of tramp materials, or all tramp materials. For example, in embodiments, the glass articles may be free or substantially free of TiO₂, Fe₂O₃, MnO, MoO₃, WO₃, Y₂O₃, CdO, As₂O₃, Sb₂O₃, sulfur-based compounds, such as sulfates, halogens, or combinations thereof.

In embodiments, the glass article may comprise greater than or equal to 58 mol % and less than or equal to 75 mol % SiO₂; greater than or equal to 10 mol % and less than or equal to 20 mol % Al₂O₃; greater than or equal to 0 mol % and less than or equal to 8 mol % B₂O₃; greater than or equal to 0 mol % and less than or equal to 6 mol % P₂O₅; and greater than or equal to 10 mol % and less than or equal to 20 mol % Na₂O. B₂O₃+P₂O₅ is greater than 0 mol % and less than or equal to 10 mol %. R₂O may be greater than or equal to 10 mol % and less than or equal to 20 mol %, wherein R₂O is the sum of Na₂O, Li₂O, and K₂O. R₂O—Al₂O₃ may be greater than or equal to 0 mol % and less than or equal to 10 mol %. RO may be greater than or equal to 0 mol % and less than or equal to 10 mol %, wherein RO is the sum of MgO, CaO, SrO, and ZnO. (R₂O+RO)—(Al₂O₃+B₂O₃) may be greater than or equal to −5 mol % and less than or equal to 10 mol %.

In embodiments, the glass article may comprise greater than or equal to 58 mol % and less than or equal to 68 mol % SiO₂; greater than or equal to 11 mol % and less than or equal to 15 mol % Al₂O₃; greater than or equal to 0 mol % and less than or equal to 7 mol % B₂O₃; greater than or equal to 0 mol % and less than or equal to 5 mol % P₂O₅; and greater than or equal to 13 mol % and less than or equal to 17 mol % Na₂O. B₂O₃+P₂O₅ is greater than 1 mol % and less than or equal to 7 mol %. R₂O may be greater than or equal to 13 mol % and less than or equal to 17 mol %, wherein R₂O is the sum of Na₂O, Li₂O, and K₂O. R₂O—Al₂O₃ may be greater than or equal to 0 mol % and less than or equal to 3 mol %. RO may be greater than or equal to 2 mol % and less than or equal to 5 mol %, wherein RO is the sum of MgO, CaO, SrO, and ZnO. (R₂O+RO)—(Al₂O₃+B₂O₃) may be greater than or equal to −3 mol % and less than or equal to 6 mol %.

In embodiments, the glass article may have a strain point greater than or equal to 450° C., greater than or equal to 500° C., or even greater than or equal to 550° C. In embodiments, the glass article may have a strain point less than or equal to 800° C., less than or equal to 750° C., or even less than or equal to 700° C. In embodiments, the glass article may have a strain point greater than or equal to 450° C. and less than or equal to 800° C., greater than or equal to 450° C. and less than or equal to 750° C., greater than or equal to 450° C. and less than or equal to 700° C., greater than or equal to 500° C. and less than or equal to 800° C., greater than or equal to 500° C. and less than or equal to 750° C., greater than or equal to 500° C. and less than or equal to 700° C., greater than or equal to 550° C. and less than or equal to 800° C., greater than or equal to 550° C. and less than or equal to 750° C., or even greater than or equal to 550° C. and less than or equal to 700° C., or any and all sub-ranges formed from any of these endpoints.

In embodiments, the glass article may have an anneal point greater than or equal to 500° C., greater than or equal to 550° C., or even greater than or equal to 600° C. In embodiments, the glass article may have an anneal point less than or equal to 850° C., less than or equal to 800° C., or even less than or equal to 750° C. In embodiments, the glass article may have an anneal point greater than or equal to 500° C. and less than or equal to 850° C., greater than or equal to 500° C. and less than or equal to 800° C., greater than or equal to 500° C. and less than or equal to 750° C., greater than or equal to 550° C. and less than or equal to 850° C., greater than or equal to 550° C. and less than or equal to 800° C., greater than or equal to 550° C. and less than or equal to 750° C., greater than or equal to 600° C. and less than or equal to 850° C., greater than or equal to 600° C. and less than or equal to 800° C., or even greater than or equal to 600° C. and less than or equal to 750° C., or any and all sub-ranges formed from any of these endpoints.

In embodiments, the glass article may have a stress optical coefficient (SOC) greater than or equal to 2.5, greater than or equal to 2.7, or even greater than or equal to 3.0. In embodiments, the glass article may have a SOC less than or equal to 4.0, less than or equal to 3.7, or even less than or equal to 3.5. In embodiments, the glass article may have a SOC, greater than or equal to 2.5 and less than or equal to 4.0, greater than or equal to 2.5 and less than or equal to 3.7, greater than or equal to 2.5 and less than or equal to 3.5, greater than or equal to 2.7 and less than or equal to 4.0, greater than or equal to 2.7 and less than or equal to 3.7, greater than or equal to 2.7 and less than or equal to 3.5, greater than or equal to 3.0 and less than or equal to 4.0, greater than or equal to 3.0 and less than or equal to 3.7, or even greater than or equal to 3.0 and less than or equal to 3.5, or any and all sub-ranges formed from any of these endpoints.

In embodiments, the glass article may have a refractive index greater than or equal to 1.2, greater than or equal to 1.3, or even greater than or equal to 1.4. In embodiments, the glass article may have a refractive index less than or equal to 2.0, less than or equal to 1.8, or even less than or equal to 1.6. In embodiments, the glass article may have a refractive index greater than or equal to 1.2 and less than or equal to 2.0, greater than or equal to 1.2 and less than or equal to 1.8, greater than or equal to 1.2 and less than or equal to 1.6, greater than or equal to 1.3 and less than or equal to 2.0, greater than or equal to 1.3 and less than or equal to 1.8, greater than or equal to 1.3 and less than or equal to 1.6, greater than or equal to 1.4 and less than or equal to 2.0, greater than or equal to 1.4 and less than or equal to 1.8, or even greater than or equal to 1.4 and less than or equal to 1.6, or any and all sub-ranges formed from any of these endpoints.

In embodiments, the glass article may comprise a Young's modulus greater than or 50 GPa, greater than or equal to 55 GPa, greater than or equal to 60 GPa, or even greater than or equal to 65 GPa. In embodiments, the glass article may comprise a Young's modulus less than or equal to 100 GPa, less than or equal to 90 GPa, less than or equal to 80 GPa, or even less than or equal to 70 GPa. In embodiments, the glass article may comprise a Young's modulus greater than or equal to 50 GPa and less than or equal to 100 GPa, greater than or equal to 50 GPa and less than or equal to 90 GPa, greater than or equal to 50 GPa and less than or equal to 80 GPa, greater than or equal to 50 GPa and less than or equal to 70 GPa, greater than or equal to 55 GPa and less than or equal to 100 GPa, greater than or equal to 55 GPa and less than or equal to 90 GPa, greater than or equal to 55 GPa and less than or equal to 80 GPa, greater than or equal to 55 GPa and less than or equal to 70 GPa, greater than or equal to 60 GPa and less than or equal to 100 GPa, greater than or equal to 60 GPa and less than or equal to 90 GPa, greater than or equal to 60 GPa and less than or equal to 80 GPa, greater than or equal to 60 GPa and less than or equal to 70 GPa, greater than or equal to 65 GPa and less than or equal to 100 GPa, greater than or equal to 65 GPa and less than or equal to 90 GPa, greater than or equal to 65 GPa and less than or equal to 80 GPa, or even greater than or equal to 65 GPa and less than or equal to 70 GPa, or any and all sub-ranges formed from any of these endpoints.

In embodiments, the glass article may have a VFT A greater than or −5 and less than or equal to 0, a VFT B greater than or equal to 4400 and less than or equal to 12000, and a VFT Tₒ greater than or equal to −70 and less than or equal to 500.

In embodiments, the glass article may have a 35 kP temperature (T₃₅ₖ) greater than or equal to 1050° C. and less than or equal to 1350° C. In embodiments, the glass article may have a T₃₅ₖ greater than or equal to 1050° C., greater than or equal to 1100° C., or even greater than or equal to 1150° C. In embodiments, the glass article may have a T₃₅ₖ less than or equal to 1350° C., less than or equal to 1300° C., or even less than or equal to 1250° C. In embodiments, the glass article may have a T₃₅ₖ greater than or equal to 1050° C. and less than or equal to 1350° C., greater than or equal to 1050° C. and less than or equal to 1300° C., greater than or equal to 1050° C. and less than or equal to 1250° C., greater than or equal to 1100° C. and less than or equal to 1350° C., greater than or equal to 1100° C. and less than or equal to 1300° C., greater than or equal to 1100° C. and less than or equal to 1250° C., greater than or equal to 1150° C. and less than or equal to 1350° C., greater than or equal to 1150° C. and less than or equal to 1300° C., or even greater than or equal to 1150° C. and less than or equal to 1250° C., or any and all sub-ranges formed from any of these endpoints.

In embodiments, the glass article may have a zirconium breakdown temperature (T_{Zr}) greater than or equal to 950° C. and less than or equal to 1450° C. In embodiments, the glass article may have a T_{Zr} greater than or equal to 1100° C. and less than or equal to 1300° C. In embodiments, the glass article may have a T_{Zr} greater than or equal to 950° C., greater than or equal to 1000° C., greater than or equal to 1050° C., greater than or equal to 1100° C., greater than or equal to 1150° C., or even greater than or equal to 1200° C. In embodiments, the glass article may have a T_{Zr} less than or equal to 1450° C., less than or equal to 1400° C., less than or equal to 1350° C., or even less than or equal to 1300° C. In embodiments, the glass article may have a T_{Zr} greater than or equal to 950° C. and less than or equal to 1450° C., greater than or equal to 950° C. and less than or equal to 1400° C., greater than or equal to 950° C. and less than or equal to 1350° C., greater than or equal to 950° C. and less than or equal to 1300° C., greater than or equal to 1000° C. and less than or equal to 1450° C., greater than or equal to 1000° C. and less than or equal to 1400° C., greater than or equal to 1000° C. and less than or equal to 1350° C., greater than or equal to 1000° C. and less than or equal to 1300° C., greater than or equal to 1050° C. and less than or equal to 1450° C., greater than or equal to 1050° C. and less than or equal to 1400° C., greater than or equal to 1050° C. and less than or equal to 1350° C., greater than or equal to 1050° C. and less than or equal to 1300° C., greater than or equal to 1100° C. and less than or equal to 1450° C., greater than or equal to 1100° C. and less than or equal to 1400° C., greater than or equal to 1100° C. and less than or equal to 1350° C., greater than or equal to 1100° C. and less than or equal to 1300° C., greater than or equal to 1150° C. and less than or equal to 1450° C., greater than or equal to 1150° C. and less than or equal to 1400° C., greater than or equal to 1150° C. and less than or equal to 1350° C., greater than or equal to 1150° C. and less than or equal to 1300° C., greater than or equal to 1200° C. and less than or equal to 1450° C., greater than or equal to 1200° C. and less than or equal to 1400° C., greater than or equal to 1200° C. and less than or equal to 1350° C., or even greater than or equal to 1200° C. and less than or equal to 1300° C., or any and all sub-ranges formed from any of these endpoints.

In embodiments, the glass article may have a liquidus viscosity greater than or equal to 100 kP. In embodiments, the glass article may have a liquidus viscosity greater than or equal to 500 kP. In embodiments, the glass article may have a liquidus viscosity greater than or equal to 200 kP. In embodiments, the glass article may have a liquidus viscosity greater than or equal to 100 kP, greater than or equal to 200 kP, greater than or equal to 400 kP, greater than or equal to 600 kP, or even greater than or equal to 800 kP. In embodiments, the glass article may have a liquidus viscosity less than or equal to 12000 kP, less than or equal to 8000 kP, less than or equal to 4000 kP, or even less than or equal to 1000 kP. In embodiments, the glass article may have a liquidus viscosity greater than or equal to 100 kP and less than or equal to 12000 kP, greater than or equal to 100 kP and less than or equal to 8000 kP, greater than or equal to 100 kP and less than or equal to 4000 kP, greater than or equal to 100 kP and less than or equal to 1000 kP, greater than or equal to 200 kP and less than or equal to 12000 kP, greater than or equal to 200 kP and less than or equal to 8000 kP, greater than or equal to 200 kP and less than or equal to 4000 kP, greater than or equal to 200 kP and less than or equal to 1000 kP, greater than or equal to 400 kP and less than or equal to 12000 kP, greater than or equal to 400 kP and less than or equal to 8000 kP, greater than or equal to 400 kP and less than or equal to 4000 kP, greater than or equal to 400 kP and less than or equal to 1000 kP, greater than or equal to 600 kP and less than or equal to 12000 kP, greater than or equal to 600 kP and less than or equal to 8000 kP, greater than or equal to 600 kP and less than or equal to 4000 kP, greater than or equal to 600 kP and less than or equal to 1000 kP, greater than or equal to 800 kP and less than or equal to 12000 kP, greater than or equal to 800 kP and less than or equal to 8000 kP, greater than or equal to 800 kP and less than or equal to 4000 kP, or even greater than or equal to 800 kP and less than or equal to 1000 kP, or any and all sub-ranges formed from any of these endpoints.

As described herein, the glass articles disclosed herein comprise formulated concentrations of and relationships between constituents to achieve a desired bendability (e.g., a ratio of compressive stress to Young's modulus being greater than or equal to 13, after the glass article is ion exchanged in a 100% KNO₃ salt bath at 410° C. for 30 minutes), scratch resistance (e.g., a Knoop scratch threshold greater than 5 N), and manufacturability (e.g., a difference between a zirconium breakdown temperature and a 35 kP temperature greater than or equal to −35° C. and a 200 P temperature less than or equal to 1720° C.).

In embodiments, the process for making a glass article includes heat treating a glass composition at one or more preselected temperatures for one or more preselected times to induce glass homogenization. In embodiments, the heat treatment for making a glass article may include (i) heating a glass composition at a rate of 1-100° C./min to glass homogenization temperature; (ii) maintaining the glass composition at the glass homogenization temperature for a time greater than or equal to 0.25 hour and less than or equal to 48 hours to produce a glass article; and (iii) cooling the formed glass article to room temperature. In embodiments, the glass homogenization temperature may be greater than or equal to 1400° C. and less than or equal to 1800° C.

In embodiments, the glass articles described herein are ion exchangeable to facilitate strengthening the glass article. In typical ion exchange processes, smaller metal ions in the glass articles are replaced or “exchanged” with larger metal ions of the same valence within a layer that is close to the outer surface of the glass article. The replacement of smaller ions with larger ions creates a compressive stress within the layer of the glass article. In embodiments, the metal ions are monovalent metal ions (e.g., Li⁺, Na⁺, K⁺, and the like), and ion exchange is accomplished by immersing the glass article in a bath comprising at least one molten salt of the larger metal ion that is to replace the smaller metal ion in the glass article. Alternatively, other monovalent ions such as Ag⁺, Tl⁺, Cu⁺, and the like may be exchanged for monovalent ions. The ion exchange process or processes that are used to strengthen the glass article may include, but are not limited to, immersion in a single bath or multiple baths of like or different compositions with washing and/or annealing steps between immersions.

Upon exposure to the glass article, the ion exchange solution (e.g., KNO₃ and/or NaNO₃ molten salt bath) may, according to embodiments, be at a temperature greater than or equal to 350° C. and less than or equal to 500° C., greater than or equal to 360° C. and less than or equal to 450° C., greater than or equal to 370° C. and less than or equal to 440° C., greater than or equal to 360° C. and less than or equal to 420° C., greater than or equal to 370° C. and less than or equal to 400° C., greater than or equal to 375° C. and less than or equal to 475° C., greater than or equal to 400° C. and less than or equal to 500° C., greater than or equal to 410° C. and less than or equal to 490° C., greater than or equal to 420° C. and less than or equal to 480° C., greater than or equal to 430° C. and less than or equal to 470° C., or even greater than or equal to 440° C. and less than or equal to 460° C., or any and all sub-ranges formed from any of these endpoints. In embodiments, the glass article may be exposed to the ion exchange solution for a duration greater than or equal to 0.5 hour and less than or equal to 24 hours, greater than or equal to 1 and less than or equal to 18 hours, greater than or equal to 2 hours and less than or equal to 12 hours, or even greater than or equal to 4 hours and less than or equal to 6 hours, or any and all sub-ranges formed from any of these endpoints.

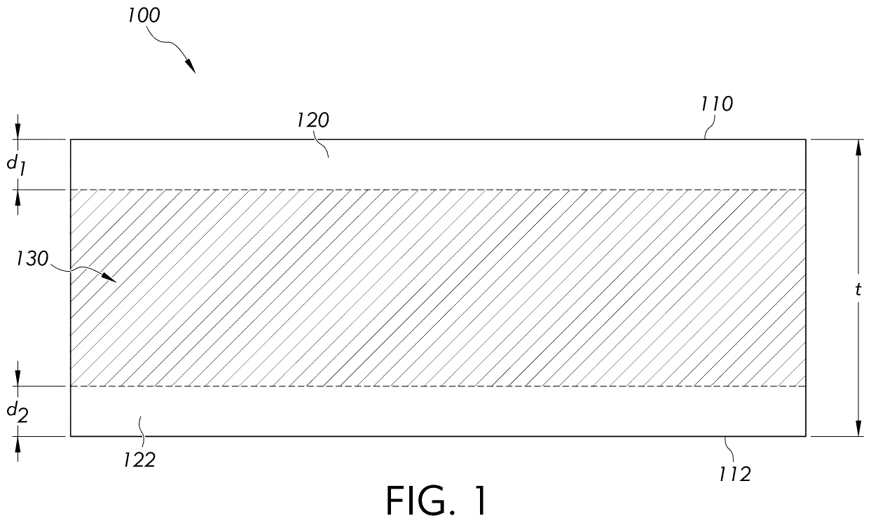

Referring now to FIG. 1, a planar, ion exchanged glass article is shown at 100. Glass article 100 has a thickness t, a first surface 110, and a second surface 120. The glass articles described herein may be any suitable thickness, which may vary depending on the particular application for use of the glass article. In embodiments, the glass article 100 may have a thickness t greater than or equal to 30 μm and less than or equal to 5000 μm. In embodiments, the glass article 100 may have a thickness t greater than or equal to 30 μm, greater than or equal to 50 μm, greater than or equal to 100 μm, greater than or equal to 500 μm, or even greater than or equal to 1000 μm. In embodiments, the glass article 100 may have a thickness t less than or equal to 5000 μm, less than or equal to 4000 μm, less than or equal to 3000 μm, less than or equal to 2000 μm, less than or equal to 1000 μm, less than or equal to 500 μm, or even less than or equal to 100 μm. In embodiments, the glass article 100 may have a thickness t greater than or equal to 30 μm and less than or equal to 5000 μm, greater than or equal to 30 μm and less than or equal to 4000 μm, greater than or equal to 30 μm and less than or equal to 3000 μm, greater than or equal to 30 μm and less than or equal to 2000 μm, greater than or equal to 30 μm and less than or equal to 1000 μm, greater than or equal to 30 μm and less than or equal to 500 μm, greater than or equal to 30 μm and less than or equal to 100 μm, greater than or equal to 50 μm and less than or equal to 5000 μm, greater than or equal to 50 μm and less than or equal to 4000 μm, greater than or equal to 50 μm and less than or equal to 3000 μm, greater than or equal to 50 μm and less than or equal to 2000 μm, greater than or equal to 50 μm and less than or equal to 1000 μm, greater than or equal to 50 μm and less than or equal to 500 μm, greater than or equal to 50 μm and less than or equal to 100 μm, greater than or equal to 30 μm and less than or equal to 5000 μm, greater than or equal to 100 μm and less than or equal to 4000 μm, greater than or equal to 100 μm and less than or equal to 3000 μm, greater than or equal to 100 μm and less than or equal to 2000 μm, greater than or equal to 100 μm and less than or equal to 1000 μm, greater than or equal to 100 μm and less than or equal to 500 μm, greater than or equal to 500 μm and less than or equal to 5000 μm, greater than or equal to 500 μm and less than or equal to 4000 μm, greater than or equal to 500 μm and less than or equal to 3000 μm, greater than or equal to 500 μm and less than or equal to 2000 μm, greater than or equal to 500 μm and less than or equal to 1000 μm, greater than or equal to 1000 μm and less than or equal to 5000 μm, greater than or equal to 1000 μm and less than or equal to 4000 μm, greater than or equal to 1000 μm and less than or equal to 3000 μm, or even greater than or equal to 1000 μm and less than or equal to 2000 μm, or any and all sub-ranges formed from any of these endpoints. While the embodiment shown in FIG. 1 depicts glass article 100 as a flat, planar sheet or plate, the glass article may have any other suitable configuration, for example, three dimensional shapes or non-planar configurations.

Ion exchanged glass article 100 has a first compressive layer 120 extending from first surface 110 to a depth of layer d₁ into the bulk of the glass article 100. In the embodiment shown in FIG. 1, glass article 100 also has a second compressive layer 122 extending from second surface 112 to a second depth of layer d₂. Glass article 100 also has a central region 130 that extends from d₁ to d₂. Central region 130 is under a tensile stress or central tension (CT), which balances or counteracts the compressive stresses of layers 120 and 122. The depth d₁, d₂ of the first and second compressive layer 120, 122 protects the glass article 100 from the propagation of flaws introduced by sharp impact to first and second surfaces 110, 112 of glass article 100, while the compressive stress minimizes the likelihood of a flaw penetrating through the depth d₁, d₂ of the first and second compressive layers 120, 122.

In embodiments, the glass article may have a potassium depth of layer (DOL), after the glass article is ion exchanged in a 100% KNO₃ salt bath at 410° C. for 30 minutes, greater than or equal to 3 μm, greater than or equal to 5 μm, greater than or equal to 7 μm, or even greater than or equal to 10 μm. In embodiments, the glass article may have a potassium DOL, after the glass article is ion exchanged in a 100% KNO₃ salt bath at 410° C. for 30 minutes, less than or equal to 25 μm, less than or equal to 20 μm, or even less than or equal to 15 μm. In embodiments, the glass article may have a potassium DOL, after the glass article is ion exchanged in a 100% KNO₃ salt bath at 410° C. for 30 minutes, greater than or equal to 3 μm and less than or equal to 25 μm, greater than or equal to 3 μm and less than or equal to 20 μm, greater than or equal to 3 μm and less than or equal to 15 μm, greater than or equal to 5 μm and less than or equal to 25 μm, greater than or equal to 5 μm and less than or equal to 20 μm, greater than or equal to 5 μm and less than or equal to 15 μm, greater than or equal to 7 μm and less than or equal to 25 μm, greater than or equal to 7 μm and less than or equal to 20 μm, greater than or equal to 7 μm and less than or equal to 15 μm, greater than or equal to 10 μm and less than or equal to 25 μm, greater than or equal to 10 μm and less than or equal to 20 μm, or even greater than or equal to 10 μm and less than or equal to 15 μm, or any and all sub-ranges formed from any of these endpoints.

In embodiments, the glass article may have a peak compressive stress (CS) greater than or equal to 750 MPa and less than or equal to 1200 MPa, after the glass article is ion exchanged in a 100% KNO₃ salt bath at 410° C. for 30 minutes. In embodiments, the glass article may have a CS greater than or equal to 850 MPa and less than or equal to 1100 MPa, after the glass article is ion exchanged in a 100% KNO₃ salt bath at 410° C. for 30 minutes. In embodiments, the glass article may have a CS, after the glass article is ion exchanged in a 100% KNO₃ salt bath at 410° C. for 30 minutes, greater than or equal to 750 MPa, greater than or equal to 800 MPa, greater than or equal to 850 MPa, greater than or equal to 900 MPa, or even greater than or equal to 950 MPa. In embodiments, the glass article may have a CS, after the glass article is ion exchanged in a 100% KNO₃ salt bath at 410° C. for 30 minutes, less than or equal to 1200 MPa, less than or equal to 1100 MPa, or even less than or equal to 1000 MPa. In embodiments, the glass article may have a CS, after the glass article is ion exchanged in a 100% KNO₃ salt bath at 410° C. for 30 minutes, greater than or equal to 750 MPa and less than or equal to 1200 MPa, greater than or equal to 750 MPa and less than or equal to 1100 MPa, greater than or equal to 750 MPa and less than or equal to 1000 MPa, greater than or equal to 800 MPa and less than or equal to 1200 MPa, greater than or equal to 800 MPa and less than or equal to 1100 MPa, greater than or equal to 800 MPa and less than or equal to 1000 MPa, greater than or equal to 850 MPa and less than or equal to 1200 MPa, greater than or equal to 850 MPa and less than or equal to 1100 MPa, greater than or equal to 850 MPa and less than or equal to 1000 MPa, greater than or equal to 900 MPa and less than or equal to 1200 MPa, greater than or equal to 900 MPa and less than or equal to 1100 MPa, greater than or equal to 900 MPa and less than or equal to 1000 MPa, greater than or equal to 950 MPa and less than or equal to 1200 MPa, greater than or equal to 950 MPa and less than or equal to 1100 MPa, or even greater than or equal to 950 MPa and less than or equal to 1000 MPa, or any and all sub-ranges formed from any of these endpoints.

As discussed herein, the glass articles described herein may achieve a desired bendability. For example, in embodiments, the glass article may comprise a ratio of a peak compressive stress (CS) to a Young's modulus (E) greater than or equal to 13, after the glass article is ion exchanged in a 100% KNO₃ salt bath at 410° C. for 30 minutes. In embodiments, the glass article may comprise a ratio of CS to E greater than or equal to 14, after the glass article is ion exchanged in a 100% KNO₃ salt bath at 410° C. for 30 minutes. In embodiments, the glass article may comprise a ratio of CS to E, after the glass article is ion exchanged in a 100% KNO₃ salt bath at 410° C. for 30 minutes, greater than or equal to 13, greater than or equal to 13.2, greater than or equal to 13.4, greater than or equal to 13.6, greater than or equal to 13.8, greater than or equal to 14, or even greater than or equal to 14.2.

As also discussed herein, the glass articles described herein may achieve a desired scratch resistance. For example, in embodiments, the glass article may comprise a Knoop scratch threshold greater than 5 N. In embodiments, the glass article may comprise a Knoop scratch threshold greater than or equal to 6 N. In embodiments, the glass article may comprise a Knoop scratch threshold greater than 5 N, greater than or equal to 6 N, greater than or equal to 7 N, greater than or equal to 8 N, or even greater than or equal to 9 N.

As also discussed herein, the glass articles may achieve a desired manufacturability. For example, in embodiments, a difference between T_{Zr} and T₃₅ₖ of the glass article may be greater than or equal to −35° C. In embodiments, a difference between T_{Zr} and T₃₅ₖ of the glass article may be greater than or equal to −30° C. In embodiments, a difference between T_{Zr} and T₃₅ₖ of the glass article may be greater than or equal to −35° C., greater than or equal to −30° C., greater than or equal to −25° C., greater than or equal to −20° C., or even greater than or equal to −15° C. In embodiments, a difference between T_{Zr} and T₃₅ₖ of the glass article may be less than or equal to 20° C., less than or equal to 15° C., less than or equal to 10° C., less than or equal to 5° C., or even less than or equal to 0° C. In embodiments, a difference between T_{Zr} and T₃₅ₖ of the glass article may be greater than or equal to −35° C. and less than or equal to 20° C., greater than or equal to −35° C. and less than or equal to 15° C., greater than or equal to −35° C. and less than or equal to 10° C., greater than or equal to −35° C. and less than or equal to 5° C., greater than or equal to −35° C. and less than or equal to 0° C., greater than or equal to −30° C. and less than or equal to 20° C., greater than or equal to −30° C. and less than or equal to 15° C., greater than or equal to −30° C. and less than or equal to 10° C., greater than or equal to −30° C. and less than or equal to 5° C., greater than or equal to −30° C. and less than or equal to 0° C., greater than or equal to −25° C. and less than or equal to 20° C., greater than or equal to −25° C. and less than or equal to 15° C., greater than or equal to −25° C. and less than or equal to 10° C., greater than or equal to −25° C. and less than or equal to 5° C., greater than or equal to −25° C. and less than or equal to 0° C., greater than or equal to −20° C. and less than or equal to 20° C., greater than or equal to −20° C. and less than or equal to 15° C., greater than or equal to −20° C. and less than or equal to 10° C., greater than or equal to −20° C. and less than or equal to 5° C., greater than or equal to −20° C. and less than or equal to 0° C., greater than or equal to −15° C. and less than or equal to 20° C., greater than or equal to −15° C. and less than or equal to 15° C., greater than or equal to −15° C. and less than or equal to 10° C., greater than or equal to −15° C. and less than or equal to 5° C., or even greater than or equal to −15° C. and less than or equal to 0° C., or any and all sub-ranges formed from any of these endpoints.

As another example as to manufacturability, in embodiments, the glass article may have a 200 P temperature (T₂₀₀) less than or equal to 1720° C. In embodiments, the glass article may have a T₂₀₀ less than or equal to 1700° C. In embodiments, the glass article may have a T₂₀₀ less than or equal to 1720° C., less than or equal to 1700° C., less than or equal to 1680° C., less than or equal to 1660° C., less than or equal to 1640° C. In embodiments, the glass article may have a T₂₀₀ greater than or equal to 1450° C., greater than or equal to 1500° C., greater than or equal to 1550° C., or even greater than or equal to 1600° C. In embodiments, the glass article may have a T₂₀₀ greater than or equal to 1450° C. and less than or equal to 1720° C., greater than or equal to 1450° C. and less than or equal to 1700° C., greater than or equal to 1450° C. and less than or equal to 1680° C., greater than or equal to 1450° C. and less than or equal to 1660° C., greater than or equal to 1450° C. and less than or equal to 1640° C., greater than or equal to 1500° C. and less than or equal to 1720° C., greater than or equal to 1500° C. and less than or equal to 1700° C., greater than or equal to 1500° C. and less than or equal to 1680° C., greater than or equal to 1500° C. and less than or equal to 1660° C., greater than or equal to 1500° C. and less than or equal to 1640° C., greater than or equal to 1450° C. and less than or equal to 1720° C., greater than or equal to 1550° C. and less than or equal to 1700° C., greater than or equal to 1550° C. and less than or equal to 1680° C., greater than or equal to 1550° C. and less than or equal to 1660° C., greater than or equal to 1550° C. and less than or equal to 1640° C., greater than or equal to 1600° C. and less than or equal to 1720° C., greater than or equal to 1600° C. and less than or equal to 1700° C., greater than or equal to 1600° C. and less than or equal to 1680° C., greater than or equal to 1600° C. and less than or equal to 1660° C., or even greater than or equal to 1600° C. and less than or equal to 1640° C., or any and all sub-ranges formed from any of these endpoints.

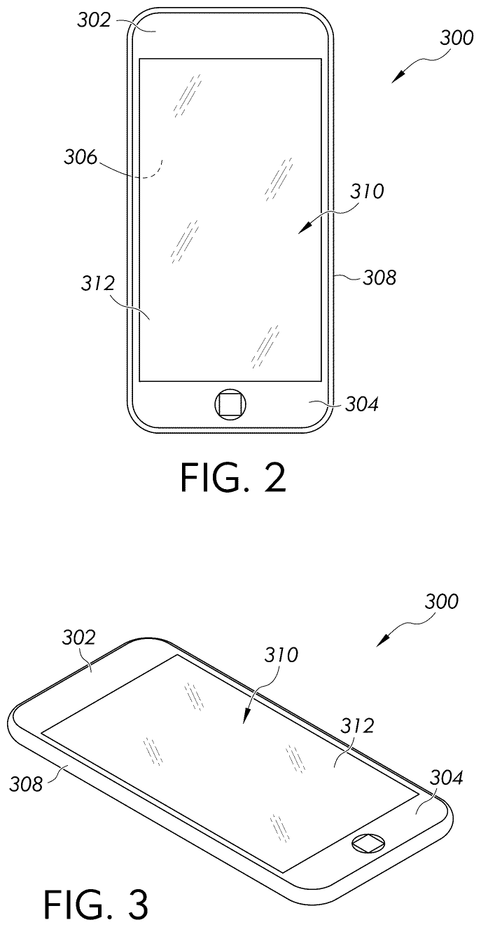

The glass articles disclosed herein may be incorporated into another article such as an article with a display (or display articles) (e.g., consumer electronics, including mobile phones, tablets, computers, navigation systems, wearable devices (e.g., watches) and the like), architectural articles, transportation articles (e.g., automotive, trains, aircraft, sea craft, etc.), appliance articles, or any article that may benefit from some transparency, scratch-resistance, abrasion resistance or a combination thereof. An exemplary article incorporating any of the glass articles disclosed herein is shown in FIGS. 2 and 3. Specifically, FIGS. 2 and 3 show a consumer electronic device 300 including a housing 302 having front 304, back 306, and side surfaces 308; electrical components (not shown) that are at least partially inside or entirely within the housing and including at least a controller, a memory, and a display 310 at or adjacent to the front surface of the housing; and a cover substrate 312 at or over the front surface of the housing such that it is over the display. In some embodiments, at least one of the cover substrate 312 or a portion of housing 302 may include any of the glass articles disclosed herein.

### EXAMPLES

In order that various embodiments be more readily understood, reference is made to the following examples, which are intended to illustrate various embodiments of the glass articles described herein.

Tables 1 and 2 show glass articles (in terms of mol %) and the respective properties of Comparative Glass Articles C1-C8 and Example Glass Articles E1-E44. Table 1 includes Comparative Glass Articles C1-C5 and E1-E11 having a strain point and an anneal point measured according to ASTM C598. Table 2 includes Comparative Glass Articles C6-C8 and Example Glass Articles E12-E44 having a strain point and an anneal point measured according to the fiber elongation method.

TABLE 1

| Example | C1 | C2 | C3 | C4 | C5 |
|---|---|---|---|---|---|
| SiO₂ | 64.23 | 68.39 | 66.10 | 67.56 | 57.43 |
| Al₂O₃ | 13.90 | 10.25 | 12.80 | 12.67 | 16.16 |
| P₂O₅ | — | — | — | — | 6.54 |
| B₂O₃ | 5.08 | — | 4.13 | 3.68 | — |
| MgO | 2.39 | 5.33 | 2.20 | 2.33 | 2.79 |
| CaO | 0.16 | 0.08 | 0.04 | — | — |
| ZnO | — | — | 0.52 | — | — |
| Li₂O | — | — | — | — | — |
| Na₂O | 14.08 | 15.70 | 14.10 | 13.67 | 17.02 |
| K₂O | 0.01 | 0.01 | 0.01 | — | — |
| TiO₂ | — | — | — | — | — |
| SnO₂ | 0.08 | 0.17 | 0.08 | 0.10 | 0.07 |
| Fe₂O₃ | — | — | — | — | — |
| Total | 99.93 | 99.93 | 99.98 | 100.00 | 100.00 |
| B₂O₃ + P₂O₅ | 5.08 | — | 4.13 | 3.68 | 6.54 |
| R₂O | 14.09 | 15.71 | 14.11 | 13.67 | 17.02 |
| RO | 2.55 | 5.41 | 2.76 | 2.33 | 2.79 |
| R₂O + RO | 16.64 | 21.12 | 16.87 | 16.00 | 19.81 |
| R₂O − Al₂O₃ | 0.19 | 5.46 | 1.31 | 1.00 | 0.86 |
| (R₂O + RO) − | −2.34 | 10.87 | −0.06 | −0.35 | 3.65 |
| (Al₂O₃ + B₂O₃) | | | | | |
| Strain | 572.2 | 591.4 | 567.0 | 572.0 | 596.0 |
| Pt. (° C.) | | | | | |
| Anneal | 623.6 | 641.4 | 617.1 | 626.0 | 646.0 |
| Pt. (° C.) | | | | | |
| Young's | 67.82 | 70.68 | 68.73 | 69.30 | 65.00 |
| Modulus (GPa) | | | | | |
| SOC (nm/mm/MPa) | 3.310 | 2.978 | 3.271 | 3.190 | 3.016 |
| Refractive | 1.500 | 1.502 | 1.500 | 1.496 | 1.492 |
| index (589.3 nm) | | | | | |
| VFT A | −2.969 | −2.084 | −2.867 | −2.580 | −3.380 |
| VFT B | 8011.964 | 6036.520 | 8197.497 | 7843.746 | 8609.000 |
| VFT Tₒ | 129.436 | 250.338 | 101.789 | 126.460 | 128.100 |
| T₂₀₀ (° C.) | 1650 | 1627 | 1688 | 1733 | 1643 |
| T₃₅ₖ (° C.) | 1196 | 1161 | 1208 | 1227 | 1215 |
| T_{Zr} (° C.) | 1160 | 1165 | 1170 | 1230 | 1245 |
| T_{Zr} − T₃₅ₖ (° C.) | −36 | 4 | −38 | 3 | 30 |
| Liquidus | 1065 | 1053 | 2936 | 1769 | 4059 |
| Viscosity (kP) | | | | | |
| Example | E1 | E2 | E3 | E4 | E5 |
| SiO₂ | 67.00 | 66.24 | 65.63 | 65.00 | 65.02 |
| Al₂O₃ | 11.99 | 12.42 | 12.87 | 13.28 | 13.34 |
| P₂O₅ | — | — | — | — | — |
| B₂O₃ | 3.51 | 3.97 | 4.38 | 4.88 | 4.69 |
| MgO | 2.75 | 2.65 | 2.57 | 2.43 | 2.45 |
| CaO | 0.50 | 0.35 | 0.18 | 0.04 | 0.04 |
| ZnO | — | — | — | — | — |
| Li₂O | — | — | — | — | — |
| Na₂O | 13.26 | 13.64 | 13.93 | 14.21 | 14.34 |
| K₂O | 0.84 | 0.57 | 0.28 | 0.01 | 0.01 |
| TiO₂ | — | — | — | — | — |
| SnO₂ | 0.09 | 0.09 | 0.09 | 0.08 | 0.08 |
| Fe₂O₃ | — | — | — | — | — |
| Total | 99.94 | 99.93 | 99.93 | 99.93 | 99.97 |
| B₂O₃ + P₂O₅ | 3.51 | 3.97 | 4.38 | 4.88 | 4.69 |
| R₂O | 14.10 | 14.21 | 14.21 | 14.22 | 14.35 |
| RO | 3.25 | 3.00 | 2.75 | 2.47 | 2.49 |
| R₂O + RO | 17.35 | 17.21 | 16.96 | 16.69 | 16.84 |
| R₂O − Al₂O₃ | 2.11 | 1.79 | 1.34 | 0.94 | 1.01 |
| (R₂O + RO) − | 1.85 | 0.82 | −0.29 | −1.47 | −1.19 |
| (Al₂O₃ + B₂O₃) | | | | | |
| Strain | 560.1 | 566.9 | 566.0 | 564.9 | 566.3 |
| Pt. (° C.) | | | | | |
| Anneal | 609.7 | 616.9 | 616.7 | 615.0 | 616.6 |
| Pt. (° C.) | | | | | |
| Young's | 70.27 | 69.71 | 69.03 | 68.23 | 68.29 |
| Modulus (GPa) | | | | | |
| SOC (nm/mm/MPa) | 3.161 | 3.187 | 3.242 | 3.263 | 3.281 |
| Refractive | 1.501 | 1.500 | 1.500 | 1.499 | 1.499 |
| index (589.3 nm) | | | | | |
| VFT A | −2.528 | −2.399 | −2.788 | −3.099 | −2.830 |
| VFT B | 7498.268 | 7145.727 | 7872.167 | 8534.456 | 7964.498 |
| VFT Tₒ | 129.213 | 160.535 | 122.371 | 86.068 | 119.873 |
| T₂₀₀ (° C.) | 1682 | 1681 | 1669 | 1666 | 1672 |
| T₃₅ₖ (° C.) | 1189 | 1190 | 1196 | 1203 | 1200 |
| T_{Zr} (° C.) | 1185 | 1190 | 1195 | 1175 | 1170 |
| T_{Zr} − T₃₅ₖ (° C.) | −4 | 0 | −1 | −28 | −30 |
| Liquidus | 3142 | 394 | 1352 | 1542 | 1866 |
| Viscosity (kP) | | | | | |

| Example | E6 | E7 | E8 | E9 | E10 | E11 |
|---|---|---|---|---|---|---|
| SiO₂ | 65.57 | 66.63 | 64.27 | 67.09 | 64.48 | 64.43 |
| Al₂O₃ | 13.06 | 12.55 | 12.82 | 11.87 | 12.88 | 12.85 |
| P₂O₅ | — | — | — | — | — | — |
| B₂O₃ | 4.39 | 3.90 | 6.03 | 1.96 | 5.68 | 5.71 |
| MgO | 2.32 | 2.05 | 2.20 | 2.77 | 1.23 | 0.02 |
| CaO | 0.04 | 0.03 | 0.04 | 0.04 | 0.03 | 0.02 |
| ZnO | 0.30 | 0.74 | 0.52 | 1.38 | 1.49 | 2.65 |
| Li₂O | — | — | — | — | — | — |
| Na₂O | 14.21 | 13.97 | 14.00 | 14.71 | 14.07 | 14.19 |
| K₂O | 0.01 | 0.01 | 0.01 | 0.01 | 0.01 | 0.01 |
| TiO₂ | — | — | — | — | 0.01 | 0.01 |
| SnO₂ | 0.08 | 0.08 | 0.08 | 0.13 | 0.07 | 0.08 |
| Fe₂O₃ | — | — | — | — | 0.01 | 0.01 |
| Total | 99.98 | 99.96 | 99.97 | 99.96 | 99.96 | 99.98 |
| B₂O₃ + P₂O₅ | 4.39 | 3.90 | 6.03 | 1.96 | 5.68 | 5.71 |
| R₂O | 14.22 | 13.98 | 14.01 | 14.72 | 14.08 | 14.20 |
| RO | 2.66 | 2.82 | 2.76 | 4.19 | 2.75 | 2.69 |
| R₂O + RO | 16.88 | 16.80 | 16.77 | 18.91 | 16.83 | 16.89 |
| R₂O − Al₂O₃ | 1.16 | 1.43 | 1.19 | 2.85 | 1.20 | 1.35 |
| (R₂O + RO) − | −0.57 | 0.35 | −2.08 | 5.08 | −1.73 | −1.67 |
| (Al₂O₃ + B₂O₃) | | | | | | |
| Strain | 565.0 | 569.0 | 553.1 | 579.8 | 551.2 | 546.8 |
| Pt. (° C.) | | | | | | |
| Anneal | 616.0 | 620.0 | 601.3 | 629.5 | 599.7 | 594.3 |
| Pt. (° C.) | | | | | | |
| Young's | 68.43 | 68.77 | 67.62 | 70.61 | 67.52 | 66.97 |
| Modulus (GPa) | | | | | | |
| SOC (nm/mm/MPa) | 3.279 | 3.285 | 3.329 | 3.144 | 3.366 | 3.444 |
| Refractive | 1.500 | 1.500 | 1.500 | 1.503 | — | — |
| index (589.3 nm) | | | | | | |
| VFT A | −2.910 | −2.686 | −2.747 | −2.513 | −2.855 | −2.986 |
| VFT B | 8076.237 | 7818.630 | 7704.605 | 7232.810 | 7944.683 | 8371.845 |
| VFT Tₒ | 112.287 | 128.681 | 115.380 | 167.233 | 103.022 | 70.685 |
| T₂₀₀ (° C.) | 1662 | 1697 | 1642 | 1670 | 1644 | 1654 |
| T₃₅ₖ (° C.) | 1196 | 1210 | 1172 | 1192 | 1177 | 1182 |
| T_{Zr} (° C.) | 1190 | 1185 | 1185 | 1170 | 1190 | 1190 |
| T_{Zr} − T₃₅ₖ (° C.) | −6 | −25 | 13 | −22 | 13 | 8 |
| Liquidus | 1954 | 2786 | 3464 | 1895 | 920 | 945 |
| Viscosity (kP) | | | | | | |

TABLE 2

| Example | C6 | C7 | C8 | E12 | E13 |
|---|---|---|---|---|---|
| SiO₂ | 63.63 | 63.41 | 60.42 | 67.24 | 65.66 |
| Al₂O₃ | 14.06 | 14.06 | 15.43 | 12.57 | 13.21 |
| P₂O₅ | 0.97 | 1.45 | 4.78 | — | 0.94 |
| B₂O₃ | 3.33 | 3.06 | — | 3.82 | 3.31 |
| MgO | 2.31 | 2.32 | 3.01 | 2.32 | 2.31 |
| CaO | 0.03 | 0.03 | 0.04 | 0.03 | 0.03 |
| ZnO | — | — | — | — | — |
| Li₂O | — | — | — | — | — |
| Na₂O | 15.42 | 15.40 | 16.21 | 13.76 | 14.30 |
| K₂O | — | 0.01 | 0.01 | — | — |
| TiO₂ | 0.09 | 0.10 | — | 0.09 | 0.09 |
| SnO₂ | 0.16 | 0.16 | 0.10 | 0.16 | 0.15 |
| Fe₂O₃ | — | — | — | — | — |
| Total | 100.00 | 100.00 | 100.00 | 100.00 | 100.00 |
| B₂O₃ + P₂O₅ | 4.29 | 4.51 | 4.78 | 3.82 | 4.24 |
| R₂O | 15.43 | 15.41 | 16.21 | 13.77 | 14.30 |
| RO | 2.33 | 2.35 | 3.05 | 2.34 | 2.34 |
| R₂O + RO | 17.76 | 17.76 | 19.26 | 16.11 | 16.64 |
| R₂O − Al₂O₃ | 1.37 | 1.35 | 0.78 | 1.20 | 1.09 |
| (R₂O + RO) − | 0.38 | 0.64 | 3.83 | −0.28 | 0.13 |
| (Al₂O₃ + B₂O₃) | | | | | |
| Strain | 586.0 | 589.0 | 647.0 | 583.0 | 585.0 |
| Pt. (° C.) | | | | | |
| Anneal | 639.0 | 642.0 | 694.0 | 637.0 | 639.0 |
| Pt. (° C.) | | | | | |
| Young's | 68.12 | 67.71 | 66.20 | 68.47 | 68.05 |
| Modulus (GPa) | | | | | |
| SOC (nm/mm/MPa) | 3.227 | 3.217 | 3.063 | 3.258 | 3.247 |
| Refractive | 1.499 | 1.498 | 1.495 | 1.498 | 1.497 |
| index (589.3 nm) | | | | | |
| VFT A | −3.487 | −3.520 | −3.937 | −3.389 | −3.502 |
| VFT B | 9386.400 | 9400.500 | 9912.700 | 9720.800 | 9666.400 |
| VFT Tₒ | 33.700 | 49.000 | 82.500 | −22.200 | 18.900 |
| T₂₀₀ (° C.) | 1655 | 1664 | 1672 | 1686 | 1685 |
| T₃₅ₖ (° C.) | 1202 | 1215 | 1251 | 1203 | 1220 |
| T_{Zr} (° C.) | 1160 | 1170 | 1210 | 1220 | 1205 |
| T_{Zr} − T₃₅ₖ (° C.) | −42 | −45 | −41 | 17 | −15 |
| Liquidus | 14576 | 8192 | 3806 | 1639 | 11212 |
| Viscosity (kP) | | | | | |
| Example | E14 | E15 | E16 | E17 | E18 |
| SiO₂ | 64.82 | 64.09 | 63.22 | 62.47 | 63.14 |
| Al₂O₃ | 13.51 | 13.81 | 14.11 | 14.44 | 14.05 |
| P₂O₅ | 1.42 | 1.88 | 2.37 | 2.79 | 1.95 |
| B₂O₃ | 3.01 | 2.74 | 2.48 | 2.22 | 2.82 |
| MgO | 2.31 | 2.28 | 2.30 | 2.30 | 2.30 |
| CaO | 0.03 | 0.03 | 0.03 | 0.03 | 0.03 |
| ZnO | — | — | — | — | — |
| Li₂O | — | — | — | — | — |
| Na₂O | 14.65 | 14.93 | 15.24 | 15.50 | 15.45 |
| K₂O | — | — | — | — | 0.01 |
| TiO₂ | 0.09 | 0.09 | 0.09 | 0.09 | 0.10 |
| SnO₂ | 0.16 | 0.15 | 0.15 | 0.15 | 0.16 |
| Fe₂O₃ | — | — | — | — | — |
| Total | 100.00 | 100.00 | 100.00 | 100.00 | 100.00 |
| B₂O₃ + P₂O₅ | 4.42 | 4.62 | 4.85 | 5.01 | 4.76 |
| R₂O | 14.65 | 14.93 | 15.25 | 15.50 | 15.45 |
| RO | 2.34 | 2.30 | 2.33 | 2.33 | 2.33 |
| R₂O + RO | 16.99 | 17.24 | 17.58 | 17.83 | 17.79 |
| R₂O − Al₂O₃ | 1.14 | 1.13 | 1.13 | 1.06 | 1.40 |
| (R₂O + RO) − | 0.47 | 0.69 | 0.98 | 1.17 | 0.92 |
| (Al₂O₃ + B₂O₃) | | | | | |
| Strain | 590.0 | 593.0 | 597.0 | 605.0 | 590.0 |
| Pt. (° C.) | | | | | |
| Anneal | 643.0 | 646.0 | 649.0 | 657.0 | 642.0 |
| Pt. (° C.) | | | | | |
| Young's | 67.50 | 67.36 | 66.88 | 66.47 | 67.43 |
| Modulus (GPa) | | | | | |
| SOC (nm/mm/MPa) | 3.232 | 3.214 | 3.192 | 3.208 | 3.227 |
| Refractive | 1.497 | 1.497 | 1.496 | 1.496 | 1.497 |
| index (589.3 nm) | | | | | |
| VFT A | −3.338 | −3.709 | −3.721 | −3.439 | −3.487 |
| VFT B | 9129.500 | 9970.900 | 10138.500 | 9188.900 | 9333.400 |
| VFT Tₒ | 46.300 | 14.400 | −19.100 | 70.100 | 48.300 |
| T₂₀₀ (° C.) | 1665 | 1673 | 1664 | 1671 | 1661 |
| T₃₅ₖ (° C.) | 1205 | 1223 | 1208 | 1221 | 1210 |
| T_{Zr} (° C.) | 1220 | 1215 | 1210 | 1200 | 1190 |
| T_{Zr} − T₃₅ₖ (° C.) | 15 | −8 | 2 | −21 | −20 |
| Liquidus | 707 | 545 | 263 | 304 | 754 |
| Viscosity (kP) | | | | | |
| Example | E19 | E20 | E21 | E22 | E23 |
| SiO₂ | 62.95 | 62.82 | 62.75 | 63.12 | 63.04 |
| Al₂O₃ | 14.06 | 14.09 | 14.06 | 14.01 | 14.13 |
| P₂O₅ | 2.43 | 2.90 | 2.91 | 2.60 | 2.69 |
| B₂O₃ | 2.53 | 2.21 | 2.27 | 2.43 | 2.45 |
| MgO | 1.31 | 2.31 | 1.33 | 2.50 | 2.48 |
| CaO | 0.03 | 0.03 | 0.02 | 0.03 | 0.03 |
| ZnO | 0.98 | — | 1.01 | — | — |
| Li₂O | — | — | — | — | — |
| Na₂O | 15.45 | 15.39 | 15.40 | 15.18 | 15.06 |
| K₂O | 0.01 | 0.01 | 0.01 | 0.01 | 0.01 |
| TiO₂ | 0.10 | 0.10 | 0.10 | — | — |
| SnO₂ | 0.16 | 0.16 | 0.15 | 0.11 | 0.10 |
| Fe₂O₃ | — | — | — | — | — |
| Total | 100.00 | 100.00 | 100.00 | 100.00 | 100.00 |
| B₂O₃ + P₂O₅ | 4.96 | 5.11 | 5.18 | 5.03 | 5.14 |
| R₂O | 15.45 | 15.39 | 15.40 | 15.19 | 15.07 |
| RO | 2.32 | 2.33 | 2.36 | 2.53 | 2.52 |
| R₂O + RO | 17.78 | 17.73 | 17.76 | 17.72 | 17.58 |
| R₂O − Al₂O₃ | 1.39 | 1.30 | 1.34 | 1.17 | 0.94 |
| (R₂O + RO) − | 1.19 | 1.43 | 1.42 | 1.27 | 1.00 |
| (Al₂O₃ + B₂O₃) | | | | | |
| Strain | 584.0 | 607.0 | 588.0 | 600.0 | 597.0 |
| Pt. (° C.) | | | | | |
| Anneal | 637.0 | 657.0 | 642.0 | 652.0 | 650.0 |
| Pt. (° C.) | | | | | |
| Young's | 66.05 | 66.54 | 66.47 | 66.67 | 66.47 |
| Modulus (GPa) | | | | | |
| SOC (nm/mm/MPa) | 3.242 | 3.206 | 3.264 | 3.202 | 3.240 |
| Refractive | 1.497 | 1.495 | 1.496 | 1.496 | 1.495 |
| index (589.3 nm) | | | | | |
| VFT A | −3.765 | −3.648 | −3.438 | −4.054 | −3.857 |
| VFT B | 10019.400 | 9898.700 | 9315.100 | 10842.900 | 10160.800 |
| VFT Tₒ | 23.300 | 2.900 | 54.100 | −39.500 | 21.500 |
| T₂₀₀ (° C.) | 1675 | 1667 | 1677 | 1667 | 1672 |
| T₃₅ₖ (° C.) | 1229 | 1211 | 1221 | 1222 | 1231 |
| T_{Zr} (° C.) | 1210 | 1220 | 1225 | 1235 | 1230 |
| T_{Zr} − T₃₅ₖ (° C.) | −19 | 9 | 4 | 13 | −1 |
| Liquidus | 384 | 316 | 220 | 2382 | 7170 |
| Viscosity (kP) | | | | | |
| Example | E24 | E25 | E26 | E27 | E28 |
| SiO₂ | 63.16 | 62.83 | 62.80 | 62.21 | 62.49 |
| Al₂O₃ | 13.93 | 14.03 | 13.93 | 14.03 | 14.00 |
| P₂O₅ | 2.55 | 2.38 | 2.35 | 2.57 | 2.36 |
| B₂O₃ | 2.45 | 2.80 | 2.80 | 2.74 | 3.25 |
| MgO | 2.47 | 2.50 | 2.48 | 2.48 | 2.38 |
| CaO | 0.03 | 0.03 | 0.03 | 0.03 | 0.04 |
| ZnO | — | — | — | — | — |
| Li₂O | — | — | — | — | — |
| Na₂O | 15.30 | 15.32 | 15.49 | 15.82 | 15.37 |
| K₂O | 0.01 | 0.01 | — | — | 0.01 |
| TiO₂ | — | — | — | — | — |
| SnO₂ | 0.10 | 0.10 | 0.10 | 0.10 | 0.10 |
| Fe₂O₃ | — | — | — | — | — |
| Total | 100.00 | 100.00 | 100.00 | 100.00 | 100.00 |
| B₂O₃ + P₂O₅ | 5.00 | 5.18 | 5.16 | 5.31 | 5.61 |
| R₂O | 15.30 | 15.32 | 15.50 | 15.82 | 15.38 |
| RO | 2.50 | 2.53 | 2.51 | 2.52 | 2.42 |
| R₂O + RO | 17.80 | 17.85 | 18.01 | 18.34 | 17.79 |
| R₂O − Al₂O₃ | 1.37 | 1.30 | 1.56 | 1.79 | 1.38 |
| (R₂O + RO) − | 1.42 | 1.03 | 1.27 | 1.56 | 0.55 |
| (Al₂O₃ + B₂O₃) | | | | | |
| Strain | 593.0 | 594.0 | 587.0 | 585.0 | 580.0 |
| Pt. (° C.) | | | | | |
| Anneal | 643.0 | 646.0 | 637.0 | 634.0 | 631.0 |
| Pt. (° C.) | | | | | |
| Young's | 66.61 | 66.61 | 66.74 | 66.61 | 66.43 |
| Modulus (GPa) | | | | | |
| SOC (nm/mm/MPa) | 3.236 | 3.198 | 3.196 | 3.198 | 3.209 |
| Refractive | 1.495 | 1.496 | 1.496 | 1.496 | 1.496 |
| index (589.3 nm) | | | | | |
| VFT A | −3.275 | −3.893 | −1.347 | −3.632 | −4.221 |
| VFT B | 8909.000 | 10425.500 | 4339.700 | 9739.800 | 11148.500 |
| VFT Tₒ | 67.800 | −30.800 | 449.400 | −1.500 | −64.000 |
| T₂₀₀ (° C.) | 1666 | 1652 | 1639 | 1640 | 1645 |
| T₃₅ₖ (° C.) | 1207 | 1205 | 1186 | 1190 | 1208 |
| T_{Zr} (° C.) | 1205 | 1205 | 1195 | 1185 | 1215 |
| T_{Zr} − T₃₅ₖ (° C.) | −2 | 0 | 9 | −5 | 7 |
| Liquidus | 1515 | 2637 | 3426 | 1742 | 2551 |
| Viscosity (kP) | | | | | |
| Example | E29 | E30 | E31 | E32 | E33 |
| SiO₂ | 61.22 | 61.79 | 61.41 | 61.03 | 59.81 |
| Al₂O₃ | 14.04 | 14.27 | 14.35 | 14.26 | 14.56 |
| P₂O₅ | 2.35 | 2.61 | 2.84 | 2.35 | 2.84 |
| B₂O₃ | 3.35 | 2.99 | 3.03 | 3.54 | 3.49 |
| MgO | 3.61 | 2.86 | 2.88 | 3.57 | 3.60 |
| CaO | 0.04 | 0.04 | 0.04 | 0.04 | 0.04 |
| ZnO | — | — | — | — | — |
| Li₂O | — | — | — | — | — |
| Na₂O | 15.28 | 15.35 | 15.35 | 15.11 | 15.56 |
| K₂O | 0.01 | 0.01 | 0.01 | 0.01 | 0.01 |
| TiO₂ | — | — | — | — | — |
| SnO₂ | 0.09 | 0.10 | 0.10 | 0.10 | 0.09 |
| Fe₂O₃ | 0.01 | — | — | 0.01 | 0.01 |
| Total | 100.00 | 100.00 | 100.00 | 100.00 | 100.00 |
| B₂O₃ + P₂O₅ | 5.70 | 5.59 | 5.87 | 5.88 | 6.33 |
| R₂O | 15.29 | 15.35 | 15.36 | 15.11 | 15.56 |
| RO | 3.66 | 2.90 | 2.92 | 3.61 | 3.64 |
| R₂O + RO | 18.94 | 18.25 | 18.28 | 18.73 | 19.20 |
| R₂O − Al₂O₃ | 1.25 | 1.09 | 1.01 | 0.86 | 1.00 |
| (R₂O + RO) − | 1.56 | 0.99 | 0.91 | 0.93 | 1.15 |
| (Al₂O₃ + B₂O₃) | | | | | |
| Strain | 584.0 | 589.0 | 588.0 | 588.0 | 584.0 |
| Pt. (° C.) | | | | | |
| Anneal | 633.0 | 639.0 | 638.0 | 637.0 | 633.0 |
| Pt. (° C.) | | | | | |
| Young's | 67.19 | 66.60 | 66.28 | 66.92 | 66.54 |
| Modulus (GPa) | | | | | |
| SOC (nm/mm/MPa) | 3.184 | 3.219 | 3.216 | 3.272 | 3.230 |
| Refractive | 1.498 | 1.497 | 1.496 | 1.498 | 1.498 |
| index (589.3 nm) | | | | | |
| VFT A | −3.722 | −3.782 | −3.687 | −3.541 | −4.115 |
| VFT B | 9607.500 | 9913.600 | 9656.900 | 9173.900 | 10376.900 |
| VFT Tₒ | 20.000 | 8.700 | 30.400 | 52.900 | −21.400 |
| T₂₀₀ (° C.) | 1615 | 1638 | 1643 | 1623 | 1596 |
| T₃₅ₖ (° C.) | 1182 | 1199 | 1204 | 1188 | 1177 |
| T_{Zr} (° C.) | 1195 | 1215 | 1210 | 1205 | 1170 |
| T_{Zr} − T₃₅ₖ (° C.) | 13 | 16 | 6 | 17 | −7 |
| Liquidus | 1076 | 1474 | 2110 | 987 | 1243 |
| Viscosity (kP) | | | | | |
| Example | E34 | E35 | E36 | E37 | E38 |
| SiO₂ | 62.13 | 61.34 | 60.32 | 61.11 | 60.22 |
| Al₂O₃ | 14.20 | 14.25 | 14.41 | 14.53 | 14.52 |
| P₂O₅ | 3.00 | 2.91 | 2.97 | 3.91 | 3.87 |
| B₂O₃ | 1.97 | 1.94 | 2.97 | 1.02 | 0.97 |
| MgO | 2.98 | 3.98 | 3.49 | 3.48 | 4.48 |
| CaO | 0.04 | 0.05 | 0.04 | 0.04 | 0.05 |
| ZnO | — | — | — | — | — |
| Li₂O | — | — | — | — | — |
| Na₂O | 15.57 | 15.41 | 15.69 | 15.80 | 15.79 |
| K₂O | 0.01 | 0.01 | 0.01 | 0.01 | 0.01 |
| TiO₂ | — | — | — | — | — |
| SnO₂ | 0.10 | 0.10 | 0.10 | 0.10 | 0.09 |
| Fe₂O₃ | 0.00 | 0.01 | 0.01 | 0.01 | 0.01 |
| Total | 100.00 | 100.00 | 100.00 | 100.00 | 100.00 |
| B₂O₃ + P₂O₅ | 4.97 | 4.86 | 5.94 | 4.92 | 4.84 |
| R₂O | 15.57 | 15.42 | 15.69 | 15.81 | 15.79 |
| RO | 3.02 | 4.03 | 3.53 | 3.52 | 4.53 |
| R₂O + RO | 18.59 | 19.44 | 19.23 | 19.33 | 20.32 |
| R₂O − Al₂O₃ | 1.38 | 1.17 | 1.28 | 1.28 | 1.27 |
| (R₂O + RO) − | 2.42 | 3.25 | 1.84 | 3.79 | 4.82 |
| (Al₂O₃ + B₂O₃) | | | | | |
| Strain | 607.0 | 612.0 | 595.0 | 633.0 | 643.0 |
| Pt. (° C.) | | | | | |
| Anneal | 655.0 | 661.0 | 644.0 | 682.0 | 692.0 |
| Pt. (° C.) | | | | | |
| Young's | 66.76 | 67.64 | 66.40 | 67.18 | 67.86 |
| Modulus (GPa) | | | | | |
| SOC (nm/mm/MPa) | 3.214 | 3.165 | 3.204 | 3.106 | 3.087 |
| Refractive | 1.496 | 1.498 | 1.498 | 1.496 | 1.498 |
| index (589.3 nm) | | | | | |
| VFT A | −3.643 | −3.674 | −3.622 | −3.724 | −3.540 |
| VFT B | 9525.200 | 9378.700 | 9322.900 | 9518.300 | 8879.200 |
| VFT Tₒ | 52.600 | 55.300 | 43.600 | 69.100 | 101.500 |
| T₂₀₀ (° C.) | 1655 | 1625 | 1618 | 1649 | 1622 |
| T₃₅ₖ (° C.) | 1216 | 1197 | 1185 | 1220 | 1200 |
| T_{Zr} (° C.) | 1205 | 1180 | 1190 | 1220 | 1200 |
| T_{Zr} − T₃₅ₖ (° C.) | −11 | −17 | 5 | 0 | 0 |
| Liquidus | 902 | 246 | 487 | 852 | 203 |
| Viscosity (kP) | | | | | |

| Example | E39 | E40 | E41 | E42 | E43 | E44 |
|---|---|---|---|---|---|---|
| SiO₂ | 58.65 | 67.21 | 65.39 | 64.38 | 62.95 | 61.03 |
| Al₂O₃ | 14.87 | 11.96 | 12.96 | 13.46 | 14.46 | 15.45 |
| P₂O₅ | 4.00 | 1.90 | 2.83 | 3.29 | 3.75 | 4.74 |
| B₂O₃ | 2.02 | — | — | — | — | — |
| MgO | 4.05 | 3.03 | 3.01 | 3.04 | 3.01 | 3.02 |
| CaO | 0.04 | 0.04 | 0.04 | 0.04 | 0.04 | 0.04 |
| ZnO | — | — | — | — | — | — |
| Li₂O | — | — | — | — | — | — |
| Na₂O | 16.24 | 15.75 | 15.68 | 15.69 | 15.68 | 15.62 |
| K₂O | 0.01 | — | 0.01 | — | — | 0.01 |
| TiO₂ | — | 0.01 | — | — | — | — |
| SnO₂ | 0.10 | 0.10 | 0.10 | 0.09 | 0.10 | 0.10 |
| Fe₂O₃ | 0.01 | — | 0.01 | 0.01 | 0.01 | 0.01 |
| Total | 100.00 | 100.00 | 100.00 | 100.00 | 100.00 | 100.00 |
| B₂O₃ + P₂O₅ | 6.02 | 1.90 | 2.83 | 3.29 | 3.75 | 4.74 |
| R₂O | 16.25 | 15.75 | 15.68 | 15.69 | 15.69 | 15.63 |
| RO | 4.10 | 3.07 | 3.05 | 3.08 | 3.05 | 3.06 |
| R₂O + RO | 20.35 | 18.82 | 18.73 | 18.77 | 18.73 | 18.68 |
| R₂O − Al₂O₃ | 1.38 | 3.79 | 2.73 | 2.23 | 1.23 | 0.18 |
| (R₂O + RO) − | 3.46 | 6.86 | 5.77 | 5.31 | 4.27 | 3.24 |
| (Al₂O₃ + B₂O₃) | | | | | | |
| Strain | 607.0 | 625.0 | 667.0 | 670.0 | 673.0 | 647.0 |
| Pt. (° C.) | | | | | | |
| Anneal | 654.0 | 673.0 | 728.0 | 731.0 | 736.0 | 697.0 |
| Pt. (° C.) | | | | | | |
| Young's | 66.84 | 68.90 | 67.70 | 67.00 | 67.00 | 66.40 |
| Modulus (GPa) | | | | | | |
| SOC (nm/mm/MPa) | 3.137 | 3.079 | 3.077 | 3.075 | 3.070 | 3.068 |
| Refractive | 1.498 | 1.494 | 1.495 | 1.494 | 1.495 | 1.494 |
| index (589.3 nm) | | | | | | |
| VFT A | −3.703 | −3.362 | −3.183 | −3.615 | −3.927 | −3.851 |
| VFT B | 9255.500 | 9313.700 | 8644.800 | 9525.200 | 10061.000 | 9614.100 |
| VFT Tₒ | 55.900 | 61.600 | 136.900 | 86.300 | 69.100 | 110.100 |
| T₂₀₀ (° C.) | 1597 | 1706 | 1713 | 1696 | 1685 | 1673 |
| T₃₅ₖ (° C.) | 1178 | 1240 | 1256 | 1254 | 1257 | 1255 |
| T_{Zr} (° C.) | 1185 | 1240 | 1265 | 1250 | 1230 | 1220 |
| T_{Zr} − T₃₅ₖ (° C.) | 7 | 0 | 9 | −4 | −27 | −35 |
| Liquidus | 451 | 832 | 558 | 441 | 1188 | 1461 |
| Viscosity (kP) | | | | | | |

As exemplified by Tables 1 and 2, glass articles comprising formulated concentrations and relationships between constituents as described herein have a difference between a zirconium breakdown temperature and a 35 kP temperature greater than or equal to −35° C. and a 200 P temperature less than or equal to 1720° C., indicating a desired manufacturability has been achieved.

Referring back to Table 1, Comparative Glass Article C2 falls outside the constituent concentration and relationship ranges described herein. In particular, B₂O₃+P₂O₅ and (R₂O+RO)—(Al₂O₃+B₂O₃) in Comparative Glass Article C2 fall outside the ranges described herein. Comparative Glass Article C2, as shown in Table 6 below) also does not have the desired scratch resistance (e.g., a Knoop scratch threshold greater than 5 N). As described herein, B₂O₃+P₂O₅ and (R₂O+RO)—(Al₂O₃+B₂O₃) within the ranges described herein lead to a desirable scratch resistance.

Referring again to Table 1, Comparative Glass Article C5 falls outside the constituent concentration ranges described herein. In particular, the concentration of SiO₂ in Comparative Glass Article C5 falls below the SiO₂ ranges described herein. As described herein, a SiO₂ concentration lower than the claimed ranges may result in poor glass forming capability and chemical durability.

Referring back to Table 1, Comparative Glass Articles C1, C3, and C6-C8 fall within the constituent concentration and relationship ranges described herein, but have a difference between T_{Zr} and T₃₅ₖ of less than −35° C., which is indicative of poor manufacturability. Comparative Glass Article C4 falls within the constituent concentration and relationship ranges described herein, but has a T₂₀₀ greater than 1720° C., which is also indicative of poor manufacturability. Comparative Glass Articles C1, C3, C4, and C6-C8 exemplify that glass articles may fall within the constituent concentration and relationship ranges described herein, but still not achieve the desired properties described herein, including manufacturability. While not wishing to be bound by theory, Comparative Glass Articles C6 and C7 do not have a sufficient concentration of P₂O₅ to offset the relatively high sum of Al₂O₃ and Na₂O, leading to a difference between T_{Zr} and T₃₅ₖ of less than −35° C.

Referring now to Tables 3 and 4, Comparative Samples SC1-SC4 and Example Samples SE1-SE16 of Comparative Glass Articles C1-C3 and C8 and Examples Glass Articles E1-E11 and E40-E44, as indicated in the tables, having a thickness of 0.8 mm were immersed in a molten salt bath comprised of 100 wt % KNO₃ at 410° C. for the listed time period. The CS, DOL, and CS/E for the ion exchanged glass articles are shown in Tables 3 and 4.

TABLE 3

| Samples | | | | | |
|---|---|---|---|---|---|
| SC1 | SC2 | SC3 | SE1 | SE2 | SE3 |
| Articles | | | | | |
| C1 | C2 | C3 | E1 | E2 | E3 |

0.25 hr.

| | | | | | | |
|---|---|---|---|---|---|---|
| CS (MPa) | 958 | 1033 | 952 | 901 | 944 | 953 |
| DOL (μm) | 7.8 | 8.7 | 7.9 | 8.1 | 8.1 | 8.1 |
| CS/E | 14.1 | 14.6 | 13.9 | 12.8 | 13.5 | 13.8 |

0.5 hr.

| | | | | | | |
|---|---|---|---|---|---|---|
| CS (MPa) | 976 | 1010 | 970 | 917 | 955 | 957 |
| DOL (μm) | 10.8 | 11.6 | 10.7 | 10.4 | 11.0 | 10.9 |
| CS/E | 14.4 | 14.3 | 14.1 | 13.1 | 13.7 | 13.9 |

1 hr.

| | | | | | | |
|---|---|---|---|---|---|---|
| CS (MPa) | 943 | 950 | 945 | 917 | 917 | 923 |
| DOL (μm) | 15.5 | 16.5 | 15.7 | 16.4 | 16.2 | 16.0 |
| CS/E | 13.9 | 13.4 | 13.7 | 13.0 | 13.2 | 13.4 |

2 hrs.

| | | | | | | |
|---|---|---|---|---|---|---|
| CS (MPa) | 919 | 974 | 917 | 883 | 896 | 902 |
| DOL (μm) | 22.4 | 23.5 | 22.6 | 23.2 | 23.3 | 22.6 |
| CS/E | 13.6 | 13.8 | 13.3 | 12.6 | 12.9 | 13.1 |

| Samples | | | | | |
|---|---|---|---|---|---|
| SE4 | SE5 | SE6 | SE7 | SE8 | SE9 |
| Articles | | | | | |
| E4 | E5 | E6 | E7 | E8 | E9 |

0.25 hr.

| | | | | | | |
|---|---|---|---|---|---|---|
| CS (MPa) | 965 | 961 | 959 | 935 | 917 | 1034 |
| DOL (μm) | 8.0 | 7.9 | 7.9 | 7.9 | 7.3 | 7.9 |
| CS/E | 14.1 | 14.1 | 14.0 | 13.6 | 13.6 | 14.6 |

0.5 hr.

| | | | | | | |
|---|---|---|---|---|---|---|
| CS (MPa) | 971 | 969 | 964 | 958 | 906 | 1026 |
| DOL (μm) | 10.7 | 10.9 | 10.7 | 10.7 | 9.5 | 10.8 |
| CS/E | 14.2 | 14.2 | 14.1 | 13.9 | 13.4 | 14.5 |

1 hr.

| | | | | | | |
|---|---|---|---|---|---|---|
| CS (MPa) | 943 | 937 | 927 | 930 | 878 | 994 |
| DOL (μm) | 15.7 | 15.7 | 15.6 | 15.9 | 13.9 | 15.8 |
| CS/E | 13.8 | 13.7 | 13.5 | 13.5 | 13.0 | 14.1 |

2 hrs.

| | | | | | | |
|---|---|---|---|---|---|---|
| CS (MPa) | 923 | 905 | 918 | 904 | 850 | — |
| DOL (μm) | 22.3 | 22.5 | 21.9 | 22.2 | 19.0 | — |
| CS/E | 13.5 | 13.3 | 13.4 | 13.1 | 12.6 | — |

Samples

| | |
|---|---|
| SE10 | SE11 |

Articles

| | |
|---|---|
| E10 | E11 |

0.25 hr.

| | | |
|---|---|---|
| CS (MPa) | 919 | 905 |
| DOL (μm) | 7.8 | 7.8 |
| CS/E | 13.6 | 13.5 |

0.5 hr.

| | | |
|---|---|---|
| CS (MPa) | 934 | 905 |
| DOL (μm) | 10.9 | 10.7 |
| CS/E | 13.8 | 13.5 |

1 hr.

| | | |
|---|---|---|
| CS (MPa) | 908 | 893 |
| DOL (μm) | 14.6 | 14.7 |
| CS/E | 13.4 | 13.3 |

2 hrs.

| | | |
|---|---|---|
| CS (MPa) | 902 | 861 |
| DOL (μm) | 20.0 | 20.3 |
| CS/E | 13.4 | 12.9 |

TABLE 4

Samples

| | | | | | |
|---|---|---|---|---|---|
| SC4 | SE12 | SE13 | SE14 | SE15 | SE16 |

Articles

| | | | | | |
|---|---|---|---|---|---|
| C8 | E40 | E41 | E42 | E43 | E44 |

1 hr.

| | | | | | | |
|---|---|---|---|---|---|---|
| CS (MPa) | 993 | 941 | 989 | 951 | 986 | 985 |
| DOL (μm) | 31.8 | 27.7 | 31.5 | 31.9 | 33.1 | 31.6 |
| CS/E | 15.0 | 13.7 | 14.6 | 14.2 | 14.7 | 14.8 |

2 hrs.

| | | | | | | |
|---|---|---|---|---|---|---|
| CS (MPa) | 985 | 910 | 961 | 938 | 985 | 970 |
| DOL (μm) | 44.8 | 38.2 | 43.9 | 45.6 | 45.2 | 43.6 |
| CS/E | 14.9 | 13.2 | 14.2 | 14.0 | 14.7 | 14.6 |

As indicated by Tables 3 and 4, glass articles comprising formulated concentrations and relationships between constituents as described herein have a ratio of CS to E greater than or equal to 13, after the glass article is ion exchanged in a 100% KNO₃ salt bath at 410° C. for 30 minutes, indicating a desired bendability has been achieved.

Referring now to Table 5, Comparative Samples SC5-SC17 and Example Samples SE17-SE70 of Comparative Glass Articles C4 and C5 and Examples Glass Articles E12-E39, as indicated in the table, having the listed thickness were immersed in a molten salt bath comprised of 100 wt % KNO₃ and 0.5% silicic acid at 420° C. for 4 hours. The CS, DOL, and CS/E for the ion exchanged glass articles are shown in Table 5.

TABLE 5

| | Samples | | | | | |
|---|---|---|---|---|---|---|
| | SC5 | SC6 | SC7 | SC8 | SC9 | SC10 |
| | Articles | | | | | |
| | C4 | C4 | C4 | C4 | C4 | C4 |
| Thickness (mm) | 0.7 | 0.7 | 0.7 | 0.7 | 0.7 | 0.7 |
| CS (MPa) | 891 | 885 | 894 | 899 | 897 | 894 |
| DOL (μm) | 37.9 | 37.9 | 39.5 | 37.8 | 37.9 | 37.8 |
| CS/E | 12.9 | 12.6 | 12.7 | 12.8 | 12.8 | 12.7 |
| | Samples | | | | | |
| | SC11 | SC12 | SC13 | SC14 | SC15 | SC16 |
| | Articles | | | | | |
| | C5 | C5 | C5 | C6 | C6 | C7 |
| Thickness (mm) | 0.8 | 0.8 | 0.8 | 0.7 | 0.7 | 0.7 |
| CS (MPa) | 955 | 955 | 950 | 926 | 920 | 915 |
| DOL (μm) | 62.2 | 62.2 | 61.2 | 46.8 | 45.6 | 49.9 |
| CS/E | 14.7 | 14.7 | 14.6 | 13.6 | 13.5 | 13.5 |
| | Samples | | | | | |
| | SC17 | SE17 | SE18 | SE19 | SE20 | SE21 |
| | Articles | | | | | |
| | C7 | E12 | E12 | E13 | E13 | E14 |
| Thickness (mm) | 0.7 | 0.7 | 0.7 | 0.6 | 0.6 | 0.7 |
| CS (MPa) | 923 | 853 | 844 | 870 | 865 | 891 |
| DOL (μm) | 50.0 | 37.8 | 38.2 | 45.6 | 46.3 | 51.1 |
| CS/E | 13.6 | 12.5 | 12.3 | 12.8 | 12.7 | 13.2 |
| | Samples | | | | | |
| | SE22 | SE23 | SE24 | SE25 | SE26 | SE27 |
| | Articles | | | | | |
| | E14 | E15 | E15 | E16 | E14 | E17 |
| Thickness (mm) | 0.7 | 0.7 | 0.7 | 0.7 | 0.7 | 0.7 |
| CS (MPa) | 877 | 888 | 882 | 897 | 903 | 895 |
| DOL (μm) | 49.6 | 52.3 | 53.5 | 55.9 | 56.2 | 59.7 |
| CS/E | 13.0 | 13.2 | 13.1 | 13.4 | 13.5 | 13.5 |
| | Samples | | | | | |
| | SE28 | SE29 | SE30 | SE31 | SE32 | SE33 |
| | Articles | | | | | |
| | E17 | E18 | E18 | E19 | E19 | E20 |
| Thickness (mm) | 0.7 | 0.7 | 0.7 | 0.7 | 0.7 | 0.7 |
| CS (MPa) | 888 | 911 | 900 | 887 | 886 | 873 |
| DOL (μm) | 60.3 | 52.8 | 53.7 | 58.0 | 53.9 | 58.6 |
| CS/E | 13.4 | 13.5 | 13.4 | 13.4 | 13.4 | 13.1 |
| | Samples | | | | | |
| | SE34 | SE35 | SE36 | SE37 | SE38 | SE39 |
| | Articles | | | | | |
| | E20 | E21 | E21 | E22 | E22 | E23 |
| Thickness (mm) | 0.7 | 0.8 | 0.8 | 0.6 | 0.6 | 0.6 |
| CS (MPa) | 892 | 851 | 855 | 874 | 876 | 844 |
| DOL (μm) | 54.1 | 58.1 | 57.9 | 58.4 | 58.4 | 60.0 |
| CS/E | 13.4 | 12.8 | 12.9 | 13.1 | 13.1 | 12.7 |

Samples

| | | | | |
|---|---|---|---|---|
| SE40 | SE41 | SE42 | SE43 | SE44 |

Articles

| | E23 | E24 | E25 | E25 | E26 |
|---|---|---|---|---|---|
| Thickness (mm) | 0.6 | 0.6 | 0.6 | 0.6 | 0.6 |
| CS (MPa) | 853 | 854 | 877 | 874 | 866 |
| DOL (μm) | 60.5 | 58.1 | 58.4 | 58.4 | 56.7 |
| CS/E | 12.8 | 12.8 | 13.2 | 13.1 | 13.0 |

| | Samples | | | | | |
|---|---|---|---|---|---|---|
| | SE45 | SE46 | SE47 | SE48 | SE49 | SE50 |
| | Articles | | | | | |
| | E26 | E27 | E28 | E28 | E29 | E29 |
| Thickness (mm) | 0.6 | 0.6 | 0.7 | 0.7 | 0.7 | 0.7 |
| CS (MPa) | 872 | 833 | 884 | 864 | 917 | 907 |
| DOL (μm) | 56.2 | 56.9 | 53.0 | 52.7 | 50.5 | 50.0 |
| CS/E | 13.1 | 12.5 | 13.3 | 13.0 | 13.6 | 13.5 |
| | Samples | | | | | |
| | SE51 | SE52 | SE53 | SE54 | SE55 | SE56 |
| | Articles | | | | | |
| | E30 | E30 | E31 | E31 | E32 | E32 |
| Thickness (mm) | 0.7 | 0.7 | 0.7 | 0.7 | 0.7 | 0.7 |
| CS (MPa) | 900 | 897 | 889 | 894 | 922 | 898 |
| DOL (μm) | 54.5 | 54.8 | 54.6 | 55.2 | 51.1 | 50.4 |
| CS/E | 13.5 | 13.5 | 13.4 | 13.5 | 13.8 | 13.4 |
| | Samples | | | | | |
| | SE57 | SE58 | SE59 | SE60 | SE61 | SE62 |
| | Articles | | | | | |
| | E33 | E33 | E34 | E34 | E5 | E35 |
| Thickness (mm) | 0.7 | 0.7 | 0.7 | 0.7 | 0.7 | 0.7 |
| CS (MPa) | 919 | 900 | 910 | 908 | 954 | 953 |
| DOL (μm) | 52.3 | 52.5 | 59.9 | 60.1 | 57.6 | 57.7 |
| CS/E | 13.8 | 13.5 | 13.6 | 13.6 | 14.1 | 14.1 |
| | Samples | | | | | |
| | SE63 | SE64 | SE65 | SE66 | SE67 | SE68 |
| | Articles | | | | | |
| | E36 | E36 | E37 | E37 | E38 | E38 |
| Thickness (mm) | 0.7 | 0.7 | 0.7 | 0.7 | 0.7 | 0.7 |
| CS (MPa) | 913 | 906 | 939 | 927 | 970 | 966 |
| DOL (μm) | 55.6 | 55.1 | 65.8 | 65.4 | 63.8 | 63.5 |
| CS/E | 13.8 | 13.6 | 14.0 | 13.8 | 14.3 | 14.2 |

Samples

| | |
|---|---|
| SE69 | SE70 |

Articles

| | E39 | E39 |
|---|---|---|
| Thickness (mm) | 0.7 | 0.7 |
| CS (MPa) | 935 | 932 |
| DOL (μm) | 59.7 | 60.0 |
| CS/E | 14.0 | 14.0 |

As indicated by Table 5, glass articles comprising formulated concentration and relationships between constituents as described herein may be ion exchanged to achieve desired ion exchange properties.

Referring now to Tables 6 and 7, Comparative Samples SC18-SC20 and Example Samples SE71-SE75 of Comparative Glass Articles C1 and C2 and Example Glass Articles E6, E8, E10, and E11, as indicated in the tables, having a thickness of 0.8 mm, were immersed in a molten salt bath comprised of 100 wt % KNO₃ at 410° C. for 1 hour (Table 6) or for 2 hours (Table 7). The DOL and Knoop scratch threshold for the ion exchanged glass articles are shown in Tables 6 and 7. The Knoop scratch threshold is provided as a range as the loads were in discrete steps (i.e., 3N, 5N, 7N, and 9 N) rather than continuous.

TABLE 6

| Samples | SC18 | SC19 | E71 | E72 |
|---|---|---|---|---|
| Articles | C1 | C2 | E6 | E8 |
| DOL (μm) | 15.5 | 16.5 | 15.6 | 13.9 |
| Knoop scratch | >9 | >3 to 5 | >9 | >9 |
| threshold (N) | | | | |

TABLE 7

| Samples | SC20 | E73 | E74 | E75 |
|---|---|---|---|---|
| Articles | C1 | E8 | E10 | E11 |
| DOL (μm) | 22.0 | 20.4 | 20.3 | 20.4 |
| Knoop scratch threshold (N) | >5 to 7 | >5 to 7 | >5 to 7 | >5 to 7 |

As indicated by Tables 6 and 7, glass articles comprising formulated concentrations and relationships described herein have a Knoop scratch threshold greater than 5 N, indicating a desired scratch resistance has been achieved.

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A glass article comprising:
greater than or equal to 58 mol % and less than or equal to 75 mol % SiO₂;
greater than or equal to 10 mol % and less than or equal to 20 mol % Al₂O₃;
greater than or equal to 0 mol % and less than or equal to 8 mol % B₂O₃;
greater than or equal to 0 mol % and less than or equal to 6 mol % P₂O₅; and
greater than or equal to 10 mol % and less than or equal to 20 mol % Na₂O, wherein
B₂O₃+P₂O₅ is greater than 0 mol % and less than or equal to 10 mol %;
R₂O is greater than or equal to 10 mol % and less than or equal to 20 mol %, wherein R₂O is the sum of Na₂O, Li₂O, and K₂O;
R₂O—Al₂O₃ is greater than or equal to 0 mol % and less than or equal to 10 mol %;
RO is greater than or equal to 0 mol % and less than or equal to 10 mol %, wherein RO is the sum of MgO, CaO, SrO, and ZnO;
(R₂O+RO)—(Al₂O₃+B₂O₃) is greater than or equal to −5 mol % and less than or equal to 10 mol %; and
the glass article comprises:
a peak compressive stress (CS) and a Young's modulus (E), a ratio of the CS to the E being greater than or equal to 13, after the glass article is ion exchanged in a 100% KNO₃ salt bath at 410° C. for 30 minutes;
a Knoop scratch threshold greater than 5 N;
a zirconium breakdown temperature (T_{Zr}) and a 35 kP temperature (T₃₅ₖ), wherein a difference between the T_{Zr} and the T₃₅ₖ being greater than or equal to −35° C.; and
a 200 P temperature (T₂₀₀) less than or equal to 1720° C.

2. The glass article of claim 1, wherein the glass article comprises a liquidus viscosity greater than or equal to 100 kP.

3. The glass article of claim 2, wherein the liquidus viscosity is greater than or equal to 500 kP.

4. The glass article of any one of claim 1, wherein the ratio of the CS to the E is greater than or equal to 14.

5. The glass article of claim 1, wherein the Knoop scratch threshold is greater than or equal to 6 N.

6. The glass article of claim 1, wherein the difference between the T_{Zr} and the T₃₅ₖ is greater than or equal to −30° C.

7. The glass article of claim 1, wherein the T₂₀₀ is less than or equal to 1700° C.

8. The glass article of claim 1, wherein T₃₅ₖ is greater than or equal to 1050° C. and less than or equal to 1350° C.

9. The glass article of claim 1, wherein the glass article comprises a thickness greater than or equal to 30 μm and less than or equal to 5000 μm.

10. The glass article of claim 1, wherein:
the CS is greater than or equal to 750 MPa and less than or equal to 1200 MPa, after the glass article is ion exchanged in a 100% KNO₃ salt bath at 410° C. for 30 minutes;
the E is greater than or equal to 50 GPa and less than or equal to 100 GPa; and
the T_{Zr} is greater than or equal to 950° C. and less than or equal to 1450° C.

11. The glass article of claim 1, wherein the glass comprises greater than or equal to 11 mol % and less than or equal to 18 mol % Al₂O₃.

12. The glass article of claim 1, wherein B₂O₃+P₂O₅ is greater than or equal to 0.5 mol % and less than or equal to 8 mol %.

13. The glass article of claim 1, wherein the glass comprises at least one of:
greater than or equal to 0.5 mol % and less than or equal to 7 mol % B₂O₃; and
greater than or equal to 0.5 mol % and less than or equal to 5 mol % P₂O₅.

14. The glass article of claim 1, wherein the glass article comprises greater than or equal to 12 mol % and less than or equal to 18 mol % Na₂O.

15. The glass article of claim 1, wherein R₂O is greater than or equal to 12 mol % and less than or equal to 18 mol %.

16. The glass article of claim 1, wherein R₂O—Al₂O₃ is greater than or equal to 0.5 mol % and less than or equal to 6 mol %.

17. The glass article of claim 1, wherein RO is greater than or equal to 1 mol % and less than or equal to 6 mol %.

18. The glass article of claim 1, wherein (R₂O+RO)—(Al₂O₃+B₂O₃) is greater than or equal to −3 mol % and less than or equal to 9 mol %.

19. The glass article of claim 1, wherein the glass article comprises at least one of:
greater than 0 mol % and less than or equal to 7 mol % MgO;
greater than 0 mol % and less than or equal to 5 mol % CaO;
greater than 0 mol % and less than or equal to 5 mol % SrO;
greater than 0 mol % and less than or equal to 5 mol % ZnO;
greater than 0 mol % and less than or equal to 5 mol % Li₂O; and
greater than 0 mol % and less than or equal to 5 mol % K₂O.

20. A consumer electronic device, comprising:
a housing having a front surface, a back surface, and side surfaces;
electrical components provided at least partially within the housing, the electrical components including at least a controller, a memory, and a display, the display being provided at or adjacent the front surface of the housing; and
the glass article of claim 1 disposed over the display.
